(19) United States
(12) Patent Application Publication
(10) Pub. No.: US 2026/0235522 A1
(43) Pub. Date: Aug. 13, 2026

(54) DUAL-FUNCTIONAL NANOPHOTONIC SENSOR FOR POLLUTANT DEGRADATION AND DETECTION

(71) Applicant: Trustees of Dartmouth College, Hanover, NH (US)

(72) Inventors: Junhu ZHOU, West Lebanon, NH (US); Congran JIN, White River Junction, VT (US); Ziqian WU, West Lebanon, NH (US); Xiaojing ZHANG, Hanover, NH (US)

(21) Appl. No.: 19/156,030

(22) PCT Filed: Feb. 23, 2024
(86) PCT No.: PCT/US2024/017067

§ 371 Date: Aug. 13, 2025

Related U.S. Application Data
(60) Provisional application No. 63/447,885, filed on Feb. 23, 2023.

(51) Int. Cl. G01N 21/65; G01N 21/94

(52) U.S. Cl. CPC G01N 21/658; G01N 21/94; G01N 2201/1296

(57) ABSTRACT

A method including providing a test system, applying a water sample to the test system, and determining a concentration of a pollutant in the water sample using surface-enhanced Raman spectroscopy of the test system. The test system may include a silicon nanofiber film, a plurality of ZnO nanorods arranged in an array on the silicon nanofiber film, and a plurality of particles disposed on the plurality of ZnO nanorods. The plurality of ZnO nanorods have a top surface and a side surface, and the side surface is arranged between the top surface and the silicon nanofiber film.

### CROSS-REFERENCE TO RELATED APPLICATIONS

This application claims priority to the provisional patent application filed on Feb. 23, 2023 and assigned U.S. App. No. 63/447,885, the disclosure of which is hereby incorporated by reference.

### FIELD OF THE DISCLOSURE

This disclosure relates to sensors for pollutants in water.

### BACKGROUND OF THE DISCLOSURE

Water is the source of all lives and clean water is critical to people's health. However, the latest published data from World Health Organization (WHO) shows that as of 2020, 2 billion people lack access to safely managed water service including 282 million people with limited services and 122 million drinking surface water. Approximately 8 out 10 people who continue to lack basic drinking water services live in rural areas. Water pollutants have become a serious threat to water quality with the economic development, global population increase, and climate changes. The pollutants can be generally classified as organic pollutants, pathogens, thermal pollution, inorganic pollutants, and nano-pollutants. The typical organic pollutants include pharmaceuticals, pesticides, organic dyes, detergents, and other industry wastes. There are growing concerns about organic contaminants since they consume oxygen in water, create toxic residues to the ecosystem, and more importantly, stay in the water body for extremely long time due to the chemical stability.

An estimated 829,000 people lose their lives each year due to unsafe water. Chemically-complex organic materials are a major water pollutant. The paper and pulp industry generates suspended solids and highly organic materials. In paper production and pulp processing, the effluents may contain adsorbable organic halogens (AOX), phenolic compounds, biocides, resin acids, non-biodegradable organic materials, tannins, sterols, lignin-derived compounds, etc. Besides the paper and pulp industry, textile factories release a large amount of wastewater. Among all pollutant created by the textile factories, dyes used for colorization play a major role in contaminating clean water.

Traditional water purification approaches that are employed for purifying water include chemical precipitation, filtration, adsorption, ion exchange, chlorination, adsorption, and distillation. Although these are widely used in industries such as wastewater treatment plants, they have limitations and drawbacks. These techniques usually require long processing time with limited removal efficiencies. Some of the techniques are also resistant to certain chemical reagents and antibiotics. Some chemical methods may cause re-contamination in the process of purifying water. In addition, to monitor the quality of the water being processed, laborious sampling and testing procedures are required. Further, current water purification methods usually have unsatisfactory purification efficiency, can create secondary pollution, and are costly. Existing water quality detection equipment lack sufficient accuracy, specificity, and limit of detection, and they often require laborious and costly testing procedures.

Therefore, there is still a demand for cost-effective and efficient water purification systems for chemically complex organic pollutants.

### SUMMARY OF THE DISCLOSURE

The present disclosure provides a dual-functional Ag nanoparticle decorated, ZnO nanorod coated silica nanofiber (AgNP—ZnONR—SNF) thin film. Embodiments of the present disclosure were analyzed for its performance for piezo-catalytic and photo-catalytic degradation and machine-learning-assisted surface-enhanced Raman scattering (SERS) sensing for organic pollutants. As discussed herein, embodiments of the ZnONR—SNF device showed improved degradation process due to its 3-dimentional (3D) fibrous structure and the large surface area. The device can be easily withdrawn from water without causing secondary contamination. Under UV irradiation, ZnONR—SNF achieved an over 98% degradation efficiency against organic pollutants in aqueous solution with a reusability for at least five times. The high degradation efficiency is also contributed by the mechanical assistance which promotes the photocatalysis process due to the piezoelectric property and semiconductor nature of ZnO. As a SERS based pollutant sensor, Ag nanoparticles (AgNPs) are decorated on ZnONR—SNF and form hotspots that enhanced the sensing signal. An enhancement factor of 1056 with an experimental detection limit of 1 μg/mL was shown.

Further, embodiments of the present disclosure include machine learning algorithms for qualitative and quantitative detection of multiple contaminants with high specificity and accuracy (92.3%).

Embodiments of the present disclosure may be used for water purification and as a sensing tool with enhanced degradation and sensing performances.

The present disclosure includes a method including providing a test system, applying a water sample to the test system, and determining a concentration of a pollutant in the water sample using Surface-Enhanced Raman Spectroscopy of the test system. In an embodiment, the test system may include a silicon nanofiber film, a plurality of ZnO nanorods arranged in an array on the silicon nanofiber film, and a plurality of particles disposed on the plurality of ZnO nanorods. The plurality of ZnO nanorods may have a top surface and a side surface, and the side surface may be arranged between the top surface and the silicon nanofiber film.

In embodiments of the present disclosure, the plurality of particles may be disposed on the top surface and the side surface of one or more of the plurality of ZnO nanorods.

In embodiments of the present disclosure, each of the plurality of ZnO nanorods may have a cross-sectional dimension of 200 nm to 3 μm.

In embodiments of the present disclosure, each of the plurality of particles may have an average diameter of 20-100 nm.

In embodiments of the present disclosure, an average distance between the plurality of particles may be 100 nm.

In embodiments of the present disclosure, a density of the plurality of ZnO nanorods may be from 10-12 nanorods in every 100 μm² area.

In embodiments of the present disclosure, the silicon nanofiber-film may have a diameter of 12 cm.

In embodiments of the present disclosure, the plurality of particles may be silver particles, gold particles, platinum particles, or other particles including precious metals.

In embodiments of the present disclosure, the pollutant may be an organic pollutant, an inorganic pollutant, a bacterial contaminant, or a virus.

In embodiments of the present disclosure, the pollutant may be the organic pollutant, and the organic pollutant may be a dye.

In embodiments of the present disclosure, the determining may include using a machine learning algorithm to analyze measurements from the surface-enhanced Raman spectroscopy.

In embodiments of the present disclosure, the machine learning algorithm may be a prior embedded neural network.

In embodiments of the present disclosure, a non-transitory computer readable medium may store a program configured to instruct a processor to execute the machine learning algorithm.

### BRIEF DESCRIPTION OF THE FIGURES

For a fuller understanding of the nature and objects of the disclosure, reference should be made to the following detailed description taken in conjunction with the accompanying figures.

FIG. 1 displays a schematic of embodiments of the Ag—ZnO—SNF thin film for organic pollutant degradation and sensing.

FIG. 2(a) displays a schematic diagram of embodiments of the synthesis procedure of the ZnONR and AgNP on an electrospun SNF thin film.

FIG. 2(b) displays a scanning electron microscopy (SEM) image of the SNF (b1), ZnONR—SNF (b2, b3), and AgNP on the top of the ZnONR (b4).

FIG. 2(c) displays energy dispersive spectrometry (EDS) mapping of the AgNP—ZnO—SNF, including a scanning electron microscopy (SEM) image (c1), Zn element (c2), O element (c3) and Ag element (c4).

FIG. 2(d) displays a diameter distribution of the SNF, AgNP, and ZnONR—SNF in a semi-logarithmic plot.

FIG. 2(e) displays an EDS spectrum of the AgNP—ZnO—SNF.

FIG. 2(f) displays a normalized UV-Visible optical absorption spectrum of the ZnONR—SNF and AgNP—ZnO—SNF.

FIG. 3(a) displays a schematic illustration of the degradation process.

FIG. 3(b) displays a schematic graphic showing the piezo- and photo-catalytic degradation process of the ZnONR.

FIG. 3(c) displays a schematic diagram of the piezoelectric property of ZnO.

FIG. 3(d) displays photocatalytic degradation results.

FIG. 3(e) displays piezo-catalytic degradation results.

FIG. 3(f) displays hybrid degradation results.

FIG. 3(g) displays photo-and piezo-catalytic degradation kinetic curves of dye solutions catalyzed by the ZnONR—SNF.

FIG. 3(h) displays hybrid degradation kinetic curves of dye solutions catalyzed by the ZnONR—SNF.

FIG. 3(i) displays degradation results of control groups without the ZnONR—SNF.

FIG. 4(a) displays the chemical structure of antibiotic Cip and dye MB.

FIG. 4(b) displays Raman spectra of Cip solution of various concentrations.

FIG. 4(c) displays Raman spectra of MB solution of various concentrations.

FIG. 4(d) displays the Raman intensity vs. concentration curve of Cip (in log₁₀ scale).

FIG. 4(e) displays the Raman intensity vs. concentration curve of MB (in log 10 scale).

FIG. 4(f) displays the SERS enhancement of MB dye (1 μg/mL) on different substrates. The inserted figure shows the zoomed area between 1600 cm⁻¹ and 1800 cm⁻¹.

FIG. 4(g) displays Raman signal mapping (10×10 data points on an area of 400×400 μm²) of the 1614 cm⁻¹ characteristic peak of the MB dye showing uniform intensity across the AgNP—ZnONR—SNF chip.

FIG. 4(h) displays 225 Raman spectra from FIG. 4(g) and the inset displays the distribution of the intensity.

FIG. 5(a) displays SEM images of a top view of ZnONR.

FIG. 5(b) displays SEM images of a side-view of ZnONR.

FIG. 5(c) displays SEM images of AgNP on the top of the ZnONR.

FIG. 6(a) displays optical images of AgNP—ZnONR—SNF with 1000 magnification.

FIG. 6(b) displays a 3D reconstruction of the AgNP—ZnONR—SNF thin film.

FIG. 7(a) displays concentration-absorbance calibration curves of MB (a).

FIG. 7(b) displays concentration-absorbance calibration curves MO.

FIG. 7(c) displays concentration-absorbance calibration curves TB.

FIG. 7(d) displays UV-Visible absorbance curves of MB under different UV irradiation time.

FIG. 7(e) displays UV-Visible absorbance curves of MO under different UV irradiation time.

FIG. 7(f) displays UV-Visible absorbance curves of TB under different UV irradiation time.

FIG. 7(g) displays a concentration-absorbance calibration curve of Cip.

FIG. 7(h) displays photocatalytic degradation results of Cip under a UV lamp and sunlight.

FIG. 7(i) displays a normalized UV-Visible absorbance curves showing the characteristic peaks of different molecules.

FIG. 8 displays results of a reusability test of the photocatalytic properties of ZnONR—SNF thin film against MB, TB, and MO.

FIGS. 9(a)-9(i) display simulations of the localized surface plasmon enabled electrical field enhancement of an embodiment of the Ag nanoparticle dimer at different location under 532 nm light; Ag nanoparticle dimer of 40 nm diameter on the top surface of ZnONR with gap of 5 nm (a), 10 nm (b), and 15 nm (c); Ag nanoparticle dimer of 40 nm diameter on the side surface of ZnONR with gap of 5 nm (d), 10 nm (e), and 15 nm (f); Ag nanoparticle dimer of 40 nm diameter at the edge of ZnONR with gap of 5 nm (g), 10 nm (h), and 15 nm (i).

FIGS. 10(a)-10(f) display simulations of the localized surface plasmon enabled electrical field enhancement of the Ag nanoparticle with different diameter and pair number under 532 nm light. Ag nanoparticle dimer of 40 nm diameter (a), 60 nm diameter (b) and 80 nm diameter (c) on the top surface of ZnONR with 5 nm gap. ZnONR with no Ag nanoparticle (d), single Ag nanoparticle of 40 nm diameter (e), and Ag nanoparticle trimer of 40 nm diameter (f). The color bar indicates electrical field enhancement.

FIG. 11(a) displays an extinction cross-section area of the AgNP number from 0 to 3 (40 nm diameter, 5 nm gap, on the top surface).

FIG. 11(b) displays an extinction cross-section area of the AgNP with different diameter (dimer, 5 nm gap, on the top surface).

FIG. 11(c) displays the extinction cross-section area of the AgNP with different gap (dimer, 40 nm diameter, on the top surface).

FIG. 11(d) displays the extinction cross-section area of the AgNP at different locations (dimer, 40 nm diameter, 5 nm gap).

FIG. 12 displays a schematic understanding of the photo-catalysis and piezo-catalysis process in ZnO nanorod under the influence of mechanical force and UV light.

FIG. 13(a) displays a schematic diagram of the fabrication process of an embodiment of the AgNP—ZnONR—SNF material.

FIG. 13(b) displays SEM images of electrospun SNFs (scale bar 20 μm).

FIG. 13(c) displays ZnO nanorods coated SNFs (scale bar 5 μm).

FIG. 13(d) displays an embodiment of AgNP—ZnONR—SNF (scale bar 1 μm).

FIG. 14 displays an organic pollutants degradation and reusability profile of Methylene blue (MB), Trypan blue (TB) and Methyl Orange (MO).

FIG. 15(a) displays raw Raman spectra of MB at different concentrations. The spectra were collected using an embodiment of AgNP—ZnONR—SNF.

FIG. 15(b) displays a calibration curve showing the relationship between MB concentration and Raman intensity in logo scale.

FIGS. 16(a)-16(c) display SEM images of embodiments of ZnONR.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

The present disclosure provides a secure, high-throughput water purification-monitoring system and methods that can quickly, accurately, quantitatively, and automatically detect multiple water contaminants (i.e., organic dyes, antibiotics) using a single, rapid test. The water samples can be easily collected from the wastewater and no sample pretreatment is required. In an embodiment, surfaced enhanced plasmonic sensing using Raman spectroscopy, or SERS, may be used. In an embodiment of the present disclosure, the main module of the degradation-sensing platform includes a silver (Ag) or gold (Au) nanoparticle decorated ZnO nanorod coated silica nanofiber matrix (Ag/AuNP—ZnONR—SNF). The Ag nanoparticles are used for their strong antibacterial and plasmonic sensing amplification properties. ZnO has strong degradation properties and may be used to degrade chemically complex organic pollutants. Further, the photo-catalytic, piezo-catalytic, and antibacterial properties of ZnO make it a powerful material in processing contaminated water. Silica nanofibers provide a 3D matrix to increase the surface-to-volume ratio and increase the water purification efficiency.

In an embodiment, a machine learning (ML) algorithm may be incorporated to achieve the automatic, quantitative analysis of multiplex detection of the contaminant(s) without the need for trained staff. The machine learning algorithm may be used to analyze measurements from the surface-enhanced Raman spectroscopy. Further, the machine learning algorithm may be a prior embedded neural network, but other machine learning algorithms may be used. Embodiments may include a non-transitory computer readable medium that may store a program to instruct a processor to execute the machine learning algorithm disclosed herein.

Embodiments of the present disclosure allows for a significant improvement of the current water contaminant degradation and monitoring technology by providing an innovative degradation-sensing technique. The embodiments disclosed herein provide means to address the challenges in water purification and monitoring in the current global water pollution crisis.

The photo-catalytic, piezo-catalytic, and antibacterial properties of ZnO makes it an eco-friendly material in processing contaminated water. One advantage of ZnO as a water treatment material is that natural sunlight containing UV light can induce its photo-catalytic reactions with persistent organic contaminants. Because of this, ZnO is a greener and more eco-friendly approach for removing organic pollutants than other techniques. However, these characteristics of ZnO in processing wastewater cannot be fully utilized without a designed material and engineered system. ZnO has been fabricated into various nanostructures such as nanospheres, nanorods, and nanoflowers. Despite these efforts, improvements are possible, such as with degradation efficiency, prevention of secondary contamination, and repeatability. ZnO nanoparticles can suffer from low surface-to-volume ratio, possible secondary contamination, and difficulty in repeated use. Embodiments of the present disclosure overcome these issues.

In addition to water purification, water quality monitoring is equally important to the environment and human health both at large and small scale. Organic pollutant detection can be challenging because of the variability and complexity of the molecules and the low limit of detection (LoD). Technologies including photo-luminescence spectroscopy, high-resolution mass spectrometry (HRMS), high-performance liquid chromatography (HPLC), and surface-enhanced Raman spectroscopy (SERS) have been used for the detection of water pollutants. Among them, SERS is widely used because of its label-free, ultrasensitive, fast, and feasible characteristics. However, mixed features, complex datasets, interferences from instrumentation noise, and sample properties can make the identification of complex Raman spectrum a challenging tool. To extract meaningful information from the Raman data, various machine learning (ML) algorithms have been developed for Raman spectrum identification, including partial least square (PLS) regression, support vector machine (SVM), convolutional neural network (CNN), recurrent neural network (RNN), prior embedded neural network (embedded neural network, neural network, or NN), and Deep learning (DL). Deep learning is a versatile method to be applied in various biomedical scenarios. Because of the multiple hidden layers of neural network, DL method is efficient in extracting complex features using multi-layer structure even without the expertise from chemists or spectroscopists.

In the embodiments disclosed herein, a nanomaterial-based system is integrated with both contaminant degradation and sensing functions. The device can purify water by degrading contaminants such as organic dyes. The device can also accurately, quantitatively, and rapidly detect multiple contaminants at the same time.

Surface plasmonic resonance can be used for quantitative multiplex water contaminant sensing. Embodiments of the sensor are based on surface plasmonic resonance (SPR) for quantitatively detecting contaminating substances in water by identifying their molecular bonding using Raman spectroscopy. Compared to a conventional water quality monitor, this technique is more accurate, faster (in minutes), more cost-effective, and requires less expertise to operate, as compared to existing methods.

In an embodiment, the testing system may perform the test on 50 samples in only a few seconds. SERS detection using the embodiments disclosed herein can be completed within one minute.

Embodiments of the nanomaterial-based platform can be constructed for optimal sensing performance. Conventional surface enhanced plasmonic sensing platforms have metal nanoparticles randomly distributed on a 2D surface such as a silicon wafer. Sensors based on this material structure have limitations in signal strength, sensitivity, and LoD. Embodiments disclosed herein include a three-layer, 3D nanostructure in which Ag or Au nanoparticles are decorated on ZnO nanorods that were grown on a silicon nanofiber. This 3D structure increases the plasmonic signal strength and, as a result, improves the sensitivity and LoD.

Embodiments of the disclosure may be used to degrade and remove common water contaminants including organic dyes. Further, embodiments may be used for quantitative, label-free, and rapid detection of the contaminants using SERS. The 3-dimensional (3D) matrix of the ZnO nanorod coated silica nanofiber and the silver nanoparticles (AgNPs) decorated on the ZnO nanorod may enhance the Raman signal of the sensing contaminants by the large amount of “hotspots” between adjacent AgNPs that maximize plasmonic coupling.

Embodiments of the AgNP—ZnONR—SNF material can include two functions: (1) alleviating water pollution caused by organic pollutants and (2) monitoring the water contaminants existence and concentration.

A principle behind the degradation ability of organic pollutants is based on the advanced oxidation processes (AOPs) generated by the photo-catalytic and piezo-catalytic properties of ZnO nanorods. AOPs are a set of chemical procedures including in-situ generation of highly reactive and oxidizing radical species which can destroy the organic pollutants.

In an instance, a mechanism of photo-catalytic degradation includes diffusing organic pollutants from the liquid phase to be absorbed to the surface of ZnONR. Then ZnONR is irradiated by the UV light with energy larger than its bandgap energy, which promotes electrons (e) from valence band (VB) to conduction band (CB) and leaves holes (h⁺) in the VB. Next, the photogenerated electron-hole (e⁻/h⁺) pairs can migrate to the ZnO nanorod surface, reacting with water and hydroxide ions (by h⁺) and oxygen (by e⁻) to generate reactive oxygen species (ROS) including hydroxyl radical (·OH) and superoxide anion (O₂^{·-}). Finally, the ROS can directly oxidize organic pollutant molecules.

In an instance, in a mechanism of piezo-catalytic degradation, upon interaction with mechanical force (generated by the water flow), ZnONR can be deformed and a strain field may be created by the deflection with the outer side being stretched while the inner side is compressed. An electric field along the ZnONR is then created inside through the piezoelectric effect producing surface charge accumulation at the opposite surface. It allows (e⁻/h⁺) to migrate to the ZnONR surface and triggers subsequent reactions similar to the photocatalytic degradation process. The piezoelectric potential also contributes to the adsorption of charged organic molecules.

Embodiments of the present disclosure further includes a machine learning algorithm to provide quick, quantitative, and accurate results without the need for trained professionals. The resulting SERS signals are plotted in a spectrum. Characteristic signal peaks are used to identify the molecules of the substances in the sample. However, mixed features, complex datasets, interferences from other substances in the sample, and instrumentation noise make data interpretation challenging, even for experienced technicians. To extract meaningful information (i.e., water contaminants) quickly and automatically from the Raman data, a machine learning algorithm can enable exploration of complex characteristics from large raw datasets and can achieve accurate results.

The SERS enhancement of the sensor can occur from 10⁵⁰ cm⁻¹ to 1650 cm⁻¹. This is an enhancement over other ranges. This can potentially be overcome by changing the nanostructure of the sensor. For instance, re-designing the ZnO nanostructure, changing the size of silver nanoparticles, and/or adding gold nanoparticles can improve enhancement.

ZnO can be used as a platform synthesis material due to its biosafety, versatility, and low-cost manufacturing. ZnO has optoelectronic and electrochemical properties that can enable various sensing and engineering applications. ZnO arrays can provide a platform for SERS-based sensing of various substances because ZnO offers a higher reproducibility and stability, larger surface-to-volume ratio, and a 3D platform.

Embodiments of the present disclosure include a test system. In an embodiment of the sensor, one or more ZnO nanorods can be grown on a silicon nanofiber film (SNF) using a hydrothermal technique. Silver particles can be decorated on the ZnO nanorods using ultraviolet (UV) irradiation. The size of the ZnO nanorods and the silver particles can be controlled during the process. Simulations using a finite element method (FEM) can be carried out to confirm the plasmonic effect of the fabricated structure. A water sample may be applied to the test system, and a concentration of a pollutant in the water sample may be determined using surface-enhanced Raman spectroscopy of the test system.

A two-step hydrothermal growth and UV irradiation protocol can be used to synthesize ZnO arrays decorated with silver particles or other particles on a silicon nanofiber film (or silicon chip). These particles contribute to the local surface plasmonic effect and an increase in silver SERS enhancement “hotspots.”

The SNF size can vary. In an embodiment, the SNF is 12 cm in diameter, but other shapes and sizes are possible. The SNF may be sized such that it can be easily handled by laboratory staff. The thickness of the SNF may be controlled by the electrospinning time of the film. In an embodiment, the SNF may be from 0.5 mm to 1 mm thick. Other electrospun nanofibers also may be used as the substrate.

The ZnO nanorods may have a homogenous dispersity. In an embodiment, the ZnO nanorods can have dimensions in the nm to μm range. The average width of the cross section of the ZnO nanorod may be from 200 nm to 3 μm, including all 0.1 nm values and ranges therebetween (e.g., 2±0.3 μm). If the cross-section of the ZnO nanorod is larger than 3 μm, then there may be more particles on the top surface of the ZnO nanorod than on the side surfaces, which would weaken the strength of a sensing signal. If the cross-section of the ZnO nanorod is smaller than 200 nm, then the ZnO nanorod may not be capable of supporting enough particles, which also would weaken the strength of a sensing signal.

In an embodiment, the height of the ZnO nanorods may be from 1 to 5 μm, including all nm values and ranges therebetween (e.g., approximately 2 μm). Without intending to be bound by any particular theory, the height of the ZnO nanorods may be on the micron scale because such a size is suitable for local signal enhancement, but large enough to support a desirable/sufficient number of particles. In various examples, the ZnO nanorods have a height to width ratio greater than 1. For example the height to width ratio may be >1:1 to 5:1, including all 0.1 ratio values and ranges therebetween. A larger height to width ratio would mean the ZnO nanorod is too narrow to support enough particles, which would weaken the strength of a sensing signal. A smaller height to width ratio would result in more particles on the top surface of the ZnO nanorods than on the side surfaces, which would weaken the strength of a sensing signal.

The cross-section of the ZnO nanorods can be different shapes. For example, the ZnO nanorods may have a hexagonal cross section, but other circular, ovoid, or polygonal shapes are possible.

Without intending to be bound by any particular theory, it is considered that the ZnO nanorods operate as scaffold. Silver and/or gold particles may be disposed (e.g., deposited) such that these particles cover (e.g., coat) at least a portion of a surface of the pillar or the whole pillar surface. The ZnO nanorods can be vertically arranged.

In an embodiment, the ZnO nanorods may be arrayed on a substrate (e.g., the thin film) as a result from the hydrothermal ZnO growth process. The density of the array of ZnO nanorods may be controlled by controlling the seeding density (the concentration of the seeding solution and the spin-coating speed of the seeding process) in the process. In various embodiments, there are about 10-12 pillars (e.g., 10, 11, or 12) in every 100 μm² area, though higher or lower densities are possible depending on the size of the pillar. Without intending to be bound by any particular theory, it is considered that the higher the density the more enhancement on the signal, and, thus, the better sensitivity and lower detection of limit of the chip.

While ZnO nanorods are used, other materials also can be used in the pillars or as a scaffold for the particles, such as titanium dioxide (TiO₂).

In embodiments of the present disclosure, silver and/or gold nanoparticles are disposed on the ZnO nanorods. The ZnO nanorods can serve as a scaffold for the silver particles.

In an embodiment, the particles are disposed on the top surface of the ZnO nanorods, but the particles also can be disposed on the side surface of the ZnO nanorods. The side surface can be between the top surface and the substrate (e.g., silicon nanofiber film). Attaching particles on the side surface and the top surface can increase sensitivity.

The silver or gold particles may have various shapes. In an embodiment, the particles may be the same shape or may be different shapes. For example, the particles may be spherical, ellipsoidal, or spike-shaped. Spherical particles may be easier to fabricate and can provide sufficient results. While other shapes (e.g., ellipsoid, spike-shape) may give stronger signal due to their aspect ratio and spike features, these particles are usually more difficult to fabricate.

In an embodiment, the silver or gold particles may be disposed in similar densities or different densities on the top side and side of the nanorods. Without intending to be bound by any particular theory, it is considered that the higher the density of particles, the better the local enhancement of the signal until the particles are too close to touch each other. For example, “hot spots” may occur when the particles are within 100 nm of each other. However, local enhancement may occur on single (or separate) particles. Hot spots or local enhancement effect will increase the signal intensity and, thus, improve the sensitivity of the chip as well as lower the limit of detection of the chip.

The particles may have various sizes. In an embodiment, the particles may be roughly the same size (e.g., a homogenous size dispersity) or different sizes. The particles may have an average diameter of 20 to 100 nm, including all 0.1 nm values and ranges therebetween (e.g., 50±8 nm). Without intending to be bound by any particular theory, it is considered the smaller the particles, the more pronounced the local enhancement. However, when the particles get too small, they cover a smaller area and decrease the enhancement effect.

While silver particles are disclosed, gold particles, platinum particles, or other particles that include precious metals can be used. A mixture of particles that each include a precious metal can be used in an embodiment. For example, the mixture can include silver and gold, silver and platinum, or gold and platinum. The mixture also can include silver, gold, and platinum. These mixtures optionally can include other precious metals or other metals.

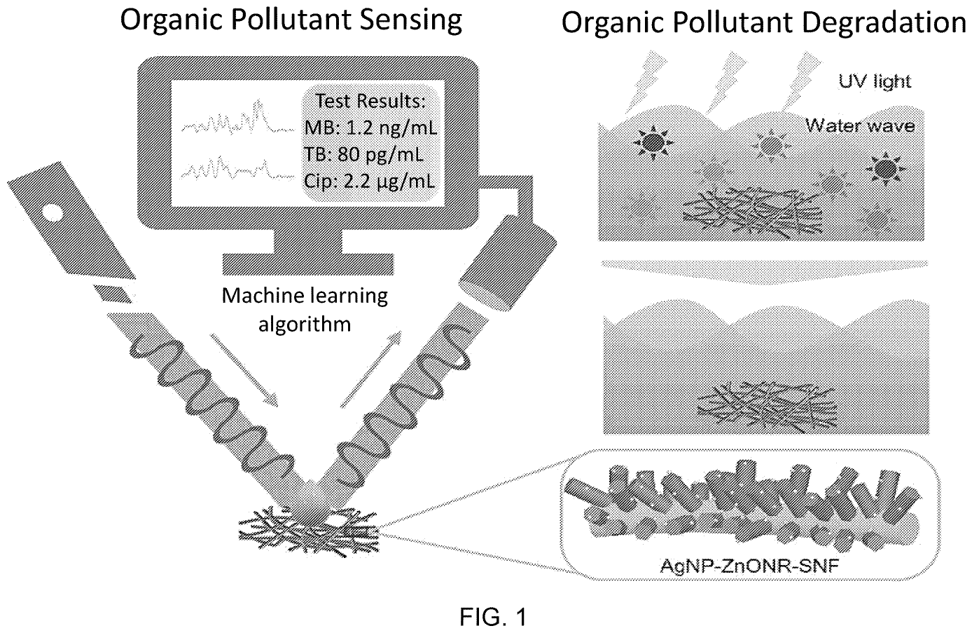

FIG. 1 displays a schematic drawing of an embodiment of the present disclosure showing the structure and the working principle of the Ag—ZnO—SNF thin film for organic pollutant degradation and sensing. As shown, embodiments of the present disclosure include a water purification and detection material based on silica nanofiber thin films, ZnO nanorods, and silver nanoparticles. ZnO nanorods grown on SNF can be recollected and prevent second pollution compared to ZnO nanoparticle powder which will likely remain in the water.

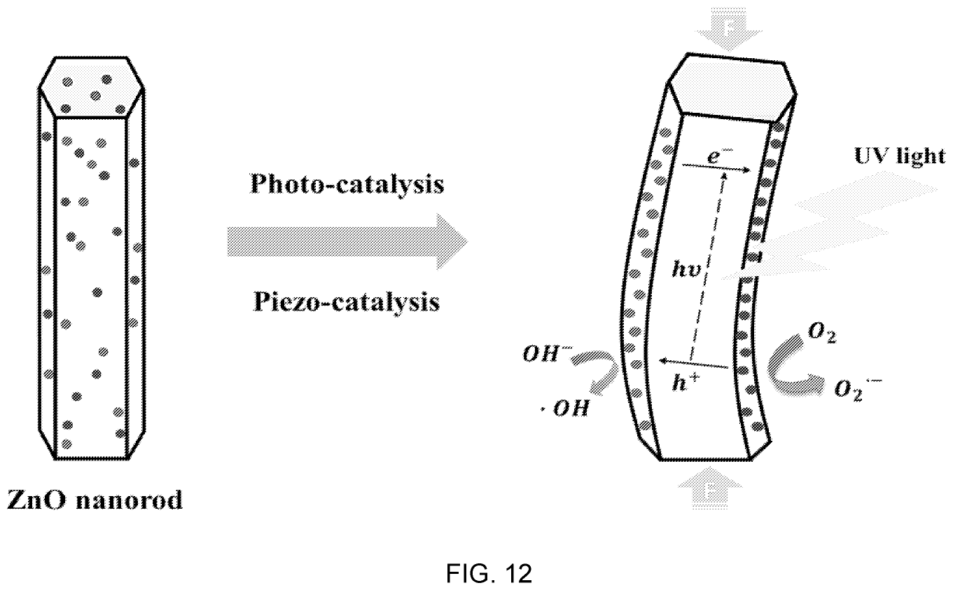

As shown in FIG. 12, hydroxyl radicals (·OH) and superoxide radicals (O₂^{·-}) formed on the surface of ZnO nanorods are powerful oxidizing agents. They can rapidly degrade the organic pollutants on the ZnO surface, which leads to the formation of intermediate compounds and finally mineralizes to nontoxic chemicals such as carbon dioxide and water.

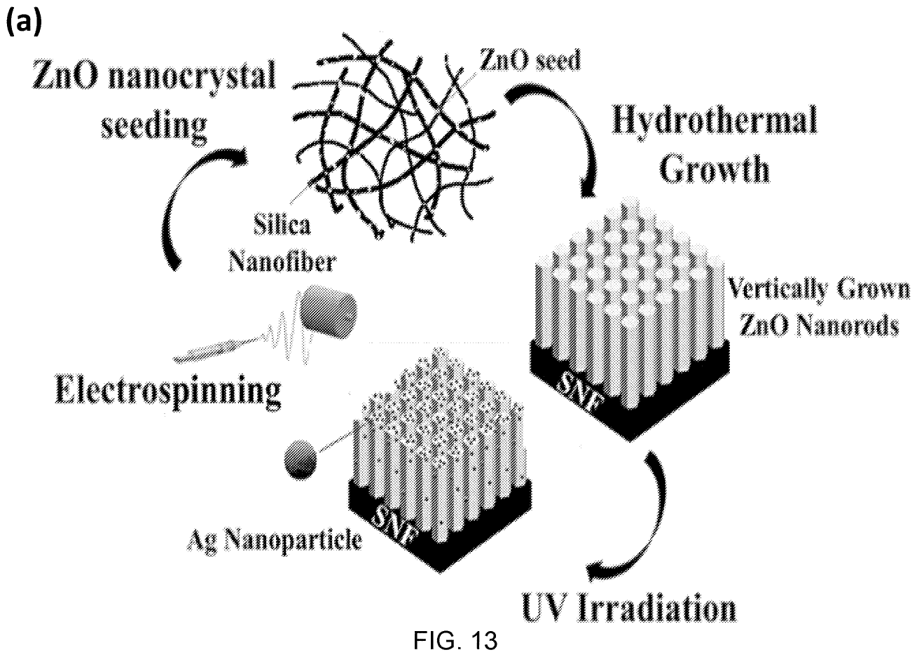

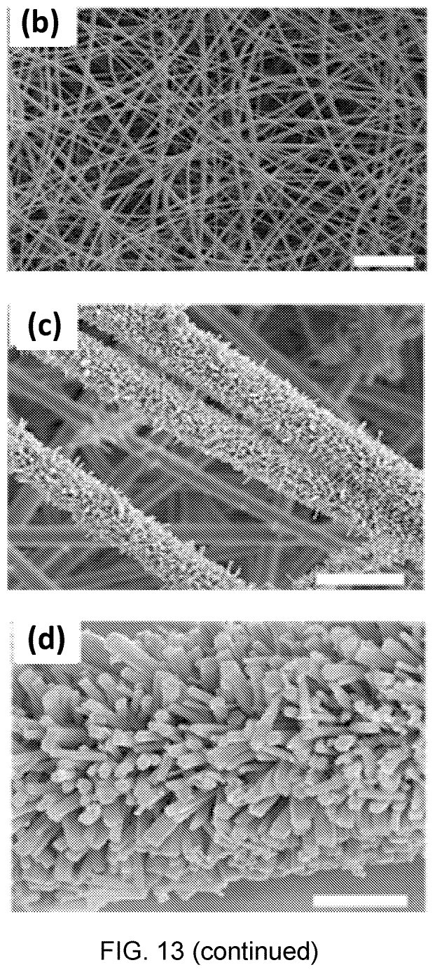

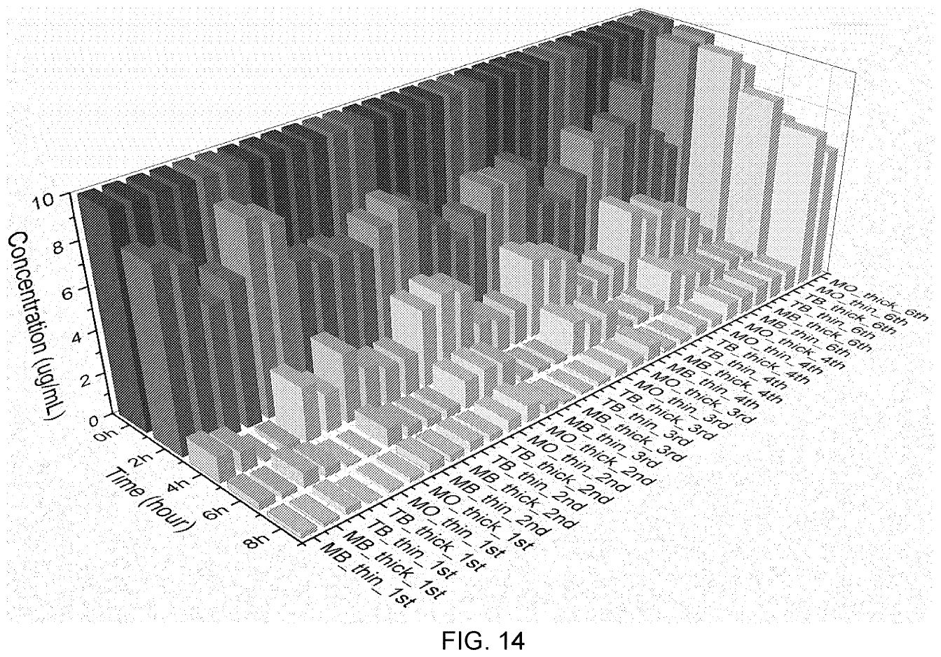

To further enhance the degradation efficiency, embodiments of the present disclosure further provide a method to grow ZnO nanorods on the surface of electrospun silica nanofibers (FIG. 13(a)). This method increases the contact area of ZnO and water pollutants to enable the reusability and to avoid floating ZnO nanorods to become new potential contaminants (FIGS. 13(b)-13(c)). Embodiments provide a high degradation efficiency against organic pollutants, and are able to be reused for at least 6 times, as shown in FIG. 14. The sensing mechanism embodiments of the present disclosure relies on Surface-enhanced Raman spectroscopy (SERS) of pollutant molecules. To enhance the Raman signal level up to several orders of magnitude, the plasmonic silver nanoparticles were decorated on the top and surface of ZnO nanorods, making it an analytical tool for in-situ and real-time water quality determination (FIG. 13(d)).

Specifically, FIG. 14 displays an organic pollutants degradation and reusability profile of Methylene blue (MB), Trypan blue (TB), and Methyl Orange (MO). The initial concentration of these dyes was 10 μg/mL in water. Data shows that ZnO nanorods coated on thin and thick SNFs have similar degradation efficiency. The ZnO/SNF films were tested for six cycles.

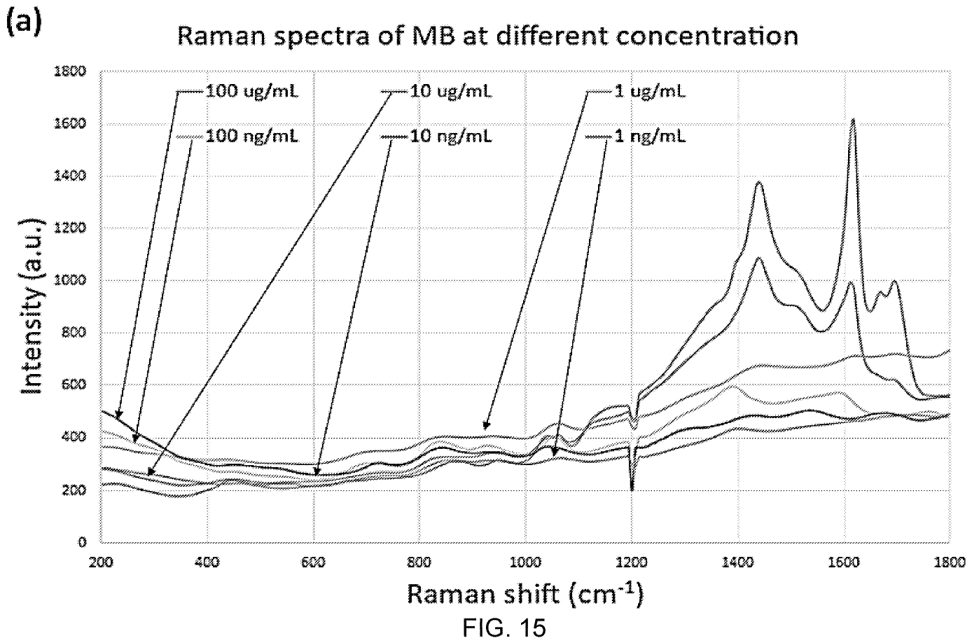

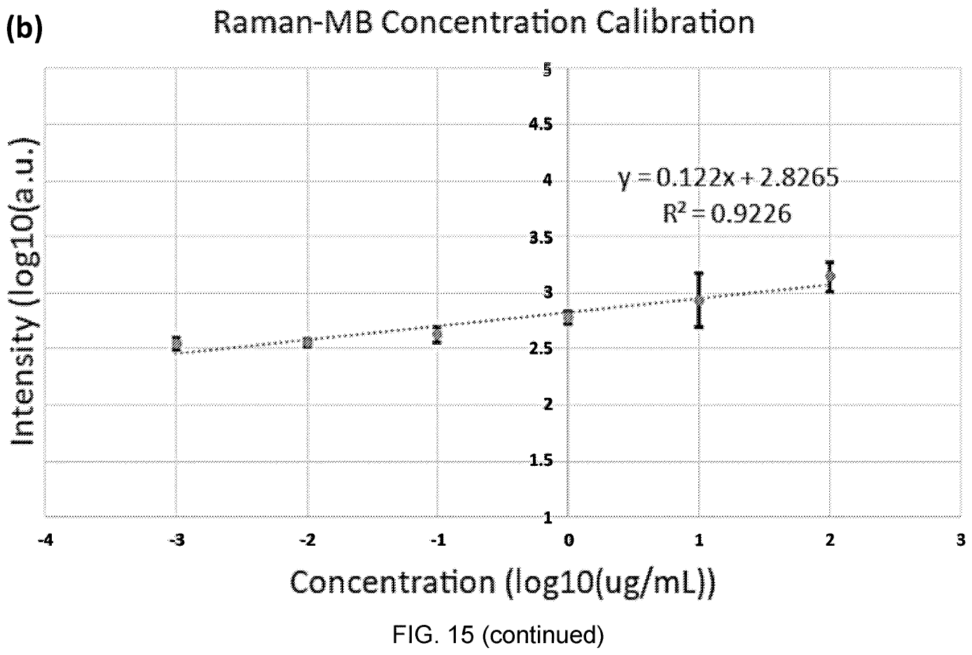

FIG. 15(a) displays raw Raman spectra of MB at different concentrations. The spectra were collected using an embodiment of AgNP—ZnONR—SNF. FIG. 15(b) displays a calibration curve showing the relationship between MB concentration and Raman intensity in log₁₀ scale.

Parts of the embodiments of the present disclosure may include, be run with, or be operated by one or more processors that may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the test system, as described throughout the present disclosure. Therefore, the above description should not be interpreted as a limitation on the embodiments of the present disclosure but merely as an illustration. Further, the methods described throughout the present disclosure may be carried out by a single processor or, alternatively, multiple processors. Additionally, the processors can be housed in a common housing or within multiple housings.

The present disclosure may also include a memory medium. The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller. For instance, the one or more processors of a controller may access a remote memory (e.g., server), accessible through a network (e.g., internet, intranet and the like).

Embodiments of the present disclosure may purify water by killing harmful organisms such as bacterial and degrade contaminants such as organic dyes. Further, embodiments may accurately, quantitatively and rapidly detect multiple contaminants at the same time.

Examples are included with this description. The examples are not meant to be limiting. While organic pollutants are disclosed, the embodiments disclosed herein can be used for inorganic pollutants, bacterial contaminants, or viruses.

Although the present disclosure has been described with respect to one or more particular embodiments, it will be understood that other embodiments of the present disclosure may be made without departing from the scope of the present disclosure.

The following example is presented to illustrate the present disclosure. It is not intended to be limiting in any matter.

### Example 1

This example provides a description of embodiments of the present disclosure, including experimental data testing such embodiments.

Access to safe drinking water is a basic human right and has long been a key part of international environmental protection efforts. Organic pollutants are a major source of water contamination that jeopardize water safety. Yet, current water purification methods usually have unsatisfactory purification efficiency, can create secondary pollution, and are costly. Existing water quality detection equipment lacks sufficient accuracy, specificity, and limits of detection. To address these unmet needs, embodiments of the present disclosure include a dual-functional Ag nanoparticle decorated, ZnO nanorod coated silica nanofiber (AgNP—ZnONR—SNF) thin film is disclosed. This thin film is analyzed for piezo-catalytic and photo-catalytic degradation and machine-learning-assisted surface-enhanced Raman scattering (SERS) sensing for organic pollutants. Embodiments of the ZnONR—SNF test system and methods show improved degradation process due to its three-dimensional (3D) fibrous structure and the large surface area. Embodiments can be withdrawn from water without causing secondary contamination. Under UV irradiation, ZnONR—SNF achieves an over 98% degradation efficiency against organic pollutants in an aqueous solution with good reusability for at least five times, though additional reuse is possible. The mechanical assistance improves the high degradation efficiency, which promotes the photocatalysis process due to the piezoelectric property and semiconductor nature of ZnO. As a SERS based pollutant sensor, Ag nanoparticles (AgNPs) are decorated on ZnONR—SNF and form hotspots that enhance the sensing signal. An enhancement factor of the SERS signal using an embodiment disclosed herein relative to using a glass substrate was 1056 with an experimental detection limit of 1 μg/mL.

### Materials and Methods

This example used the following chemical and reagents: Tetraethyl orthosilicate (TEOS, 98%), formic acid, ethanol, Polyvinylpyrrolidone (PVP, Mw=1,300,000 g mol-1), Zinc acetate ((CH3CO2)2Zn, 99.99%), zinc nitrate hexahydrate (Zn(NO3)2·6H2O, 98.0%), hexamethylenetetramine (C6H12N4, HMTA, ≥99.0%), silver nitrate powder (AgNO3, ≥99.0%), Methylene blue (MB, C16H18ClN3S·xH2O, Mw=319.85 g mol-1), Trypan Blue (TB, C34H24N6O14S4Na4, Mw=960.81 g mol-1), Methyl Orange (MO, C14H14N3NaO3S, Mw=327.33 g mol-1) and Ciprofloxacin (Cip, C17H18FN3O3, Mw=331.34 g mol-1) were purchased from Sigma-Aldrich Inc. Deionized (DI) water is from a Milli-Q water ultrapure water purification system.

In this example, the silica nanofiber thin film was prepared through electrospinning according to a reported protocol with modifications. In a typical run, 1.9 g of TEOS, 3.15 g of ethanol, 2.0 g of water and 0.04 g of formic acid were mixed with 0.9 g of PVP. The mixture was stirred for 1 hour at room temperature until a transparent solution was formed. The solution was electrospun at a feed rate of 0.9 mL/h through a 22 G stainless needle under a high voltage (16 kV). The ejected silica nanofibers were collected by a flat aluminum plate collector 10 cm away from the needle tip. The silica nanofiber thin film was peeled off from the aluminum foil gently and was then subjected to the calcination for 3 hours at 800° C. to remover PVP and other solvent residues.

In this example, the ZnO nanorods were created based on a seeding-growth method. First, the silica nanofiber thin film was immersed in 5 mM zinc acetate solution (in DI water) and then vacuumized to remove air bubbles. It was then transferred into an oven at 180° C. for 20 minutes for thermal decomposition of the zinc acetate to create ZnO seeds. This process was repeated 3 times. Next, zinc nitrate hexahydrate (35 mM) and HMTA (25 mM) was added to 45 mL of DI water to provide the hydrothermal growth solution. Next, the seeded thin film was placed in the growth solution in a beaker which was covered by aluminum foil and placed in a water bath for 3 hours at a temperature of 90° C. This growth cycle was repeated twice to form the ZnO nanorods. Finally, the thin film was rinsed with DI water to remove excessive ZnO residuals and dried in an oven at 50° C.

Silver nanoparticle decoration: In this example, Ag nanoparticles were fabricated on top of the ZnO nanoarray by UV irradiation. The fabricated thin film was immersed in a 5 mM AgNO₃ solution (in DI water) and irradiated under a UV lamp (365 nm, 15 W) for 30 minutes. The film was then washed with DI water and dried in an oven at 50° C.

SEM and EDS characterization: The morphologies of SNFs, ZnONR—SNF, and AgNP@ZnONR—SNF were studied by scanning electron microscopy (SEM) performing on a FEI Helios 5CX dual beam scanning electron microscope operating at 5 kV. The energy-dispersive X-ray spectroscopic (EDS) measurements and the chemical mapping were performed with the SDD X-ray detector (OXFORD®) attached to the SEM microscope operating at 10 kV.

Photo- and Piezo-catalytic Degradation: All organic molecules were dissolved in distilled water at a concentration of 10 μg/mL under sonication at room temperature. Calibration curves were obtained by considering the characteristic UV-Vis absorbance values (MB at 664 nm, TB at 590 nm, MO at 463 nm, 2,4-D at 282 nm, and Cip at 270 nm), obtained from a series of diluted solutions at prefixed concentration values (SI Figure). ZnONR—SNF films were cut into 0.8×0.8 cm² pieces and employed in glass vials with 3 mL of pollutant solutions for each degradation experiment. The control experiments were carried out in the absence of ZnONR—SNF films. Photocatalytic degradation experiments were carried out by applying a UV lamp (irradiated from upper side of the vials) at a fixed distance of around 5 cm with 30 mW cm⁻² of UV light irradiation intensity. In piezo-catalytic degradation experiments, vials were fixed on the MTS 2/4 digital shaker orbiting at 300 rpm. In hybrid experiments, vials were fixed at the shaker and irradiated by the UV lamp simultaneously. All experiments were performed in the dark room at room temperature.

The degradation efficiency was measured by means of light absorbance. First, 30 μL of solution was withdrawn from the vials at a 2-hour time interval (0 hours, 2 hours, 4 hours, 6 hours, 8 hours) and placed in a 96 well UV-Star microplate. Then the light absorbance was read by a microplate reader (TECAN SPARK 10M) at each characteristic peak wavelength. According to the light absorbance readout and recorded calibration curve obtained previously, the concentration of the organic pollutants after degradation was finalized. The degradation efficiency can be calculated by the following equation:

$$Degradation efficiency = \frac{{C}_{0} - C}{{C}_{0}} \times 100 \%$$

Where C₀ is the initial concentration and C is the measured concentration at different times.

SERS detection: In this example, the SERS measurements were processed in a liquid system. The AgNP@ZnONR—SNF was first cut into a square piece (0.5 cm×0.5 cm). Then the substrate was focused with a 10× objective lens. Next, the sample aqueous solution (10 μl) was added into the piece. Finally, SERS signals were obtained point-by-point from the 15×15 grid using a 532 nm laser as an excited source.

This example used two output modes to show the qualitative and quantitative detection results. In the first mode, the NN was a classification (sigmoid as activation layer) to show the analyte components and concentration level. The output of NN was a tensor, either 0 or 1, with part of the tensor indicating the analyte component and part of the tensor showing if the specific analyte is above a typical cutoff concentration. In the second mode, the NN was a regression (ReLU as activation layer) to directly show the concentration ratios of multiple analytes. The output is a tensor with arbitrary numbers showing the concentration ratios of each analyte, where an extremely small number indicates the specific analyte does not exist. Both of the two modes can output the qualitative and quantitative detection of mixed analytes to satisfy different application requests.

### Results

### Characterization

In this example, an electrospun SNF was formed on aluminum foil. The electrospun SNF thin film was peeled and collected from the aluminum foil and had a diameter of approximately 12 cm. The electrospun SNF thin film was flexible. Scanning electron microscopy (SEM) was performed on a FEI Helios 5CX dual beam scanning electron microscope operating at 5 kV. The energy-dispersive X-ray spectroscopic (EDS) measurements and the chemical mapping were performed with the SDD X-ray detector (AMETEK®) attached to the TESCAN Vega3 scanning electron microscope operating at 30 kV.

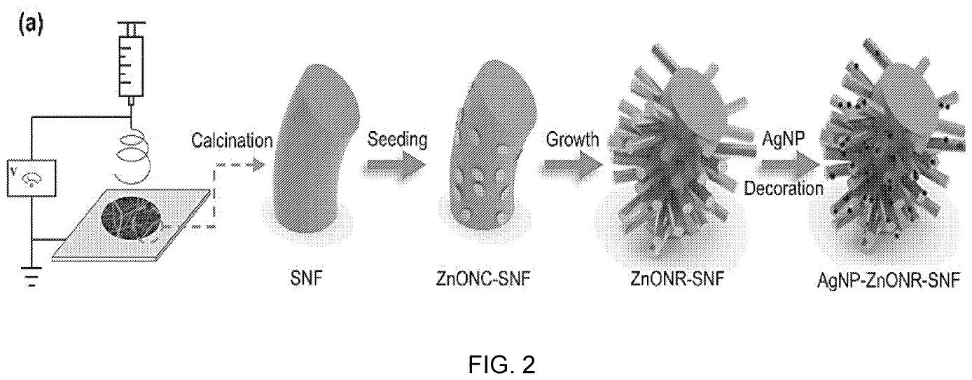

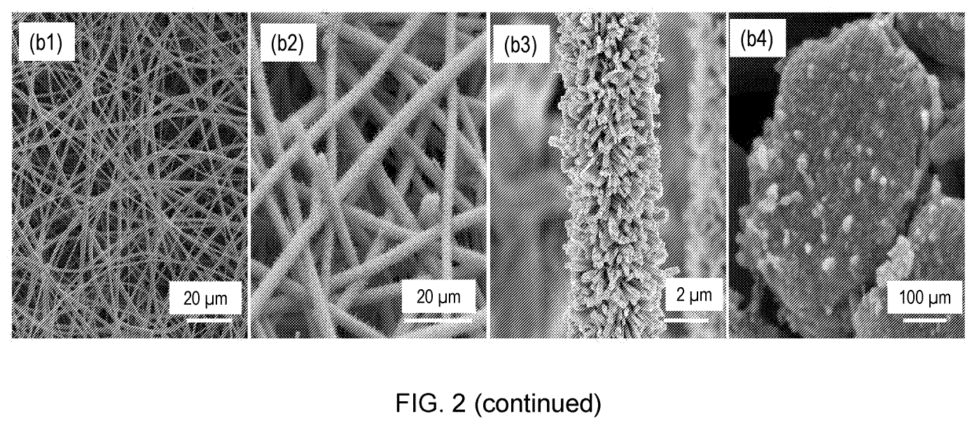

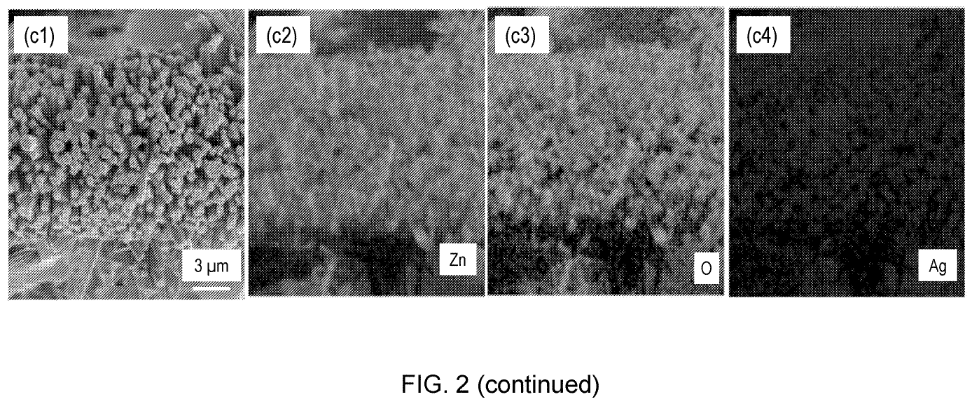

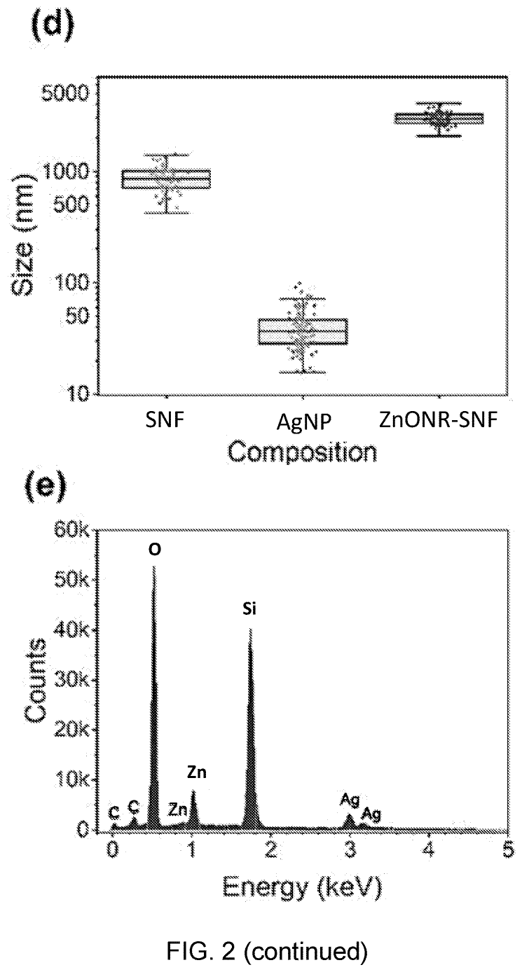

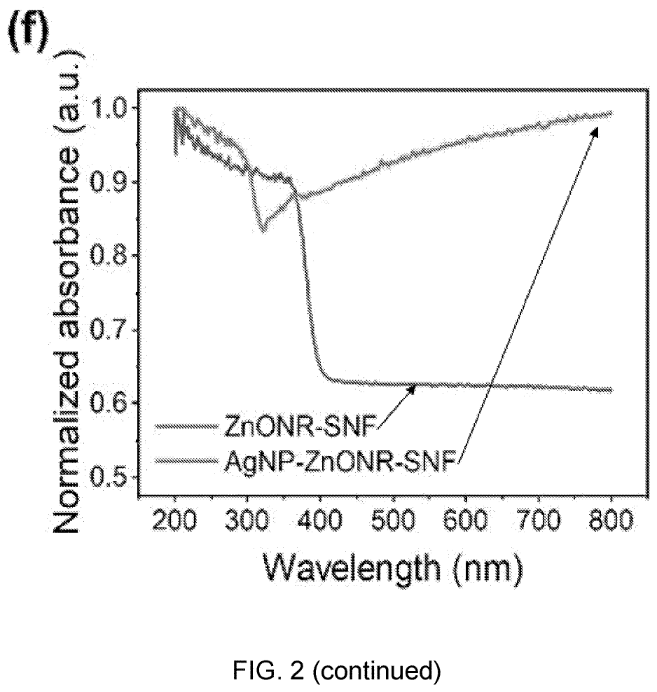

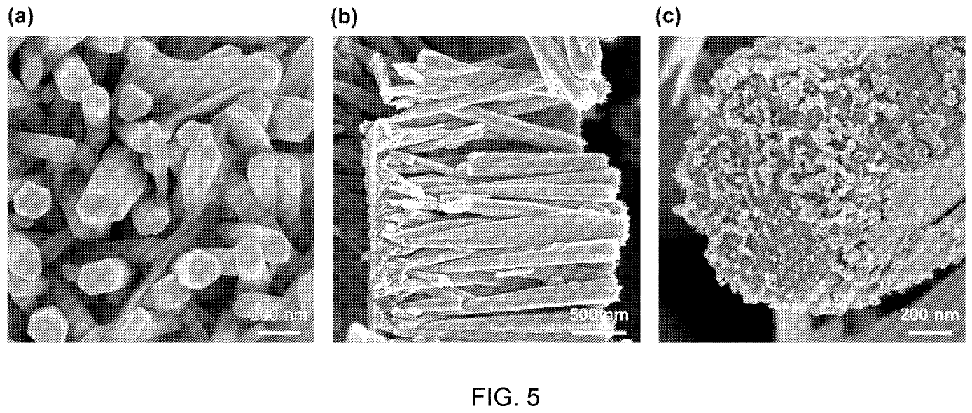

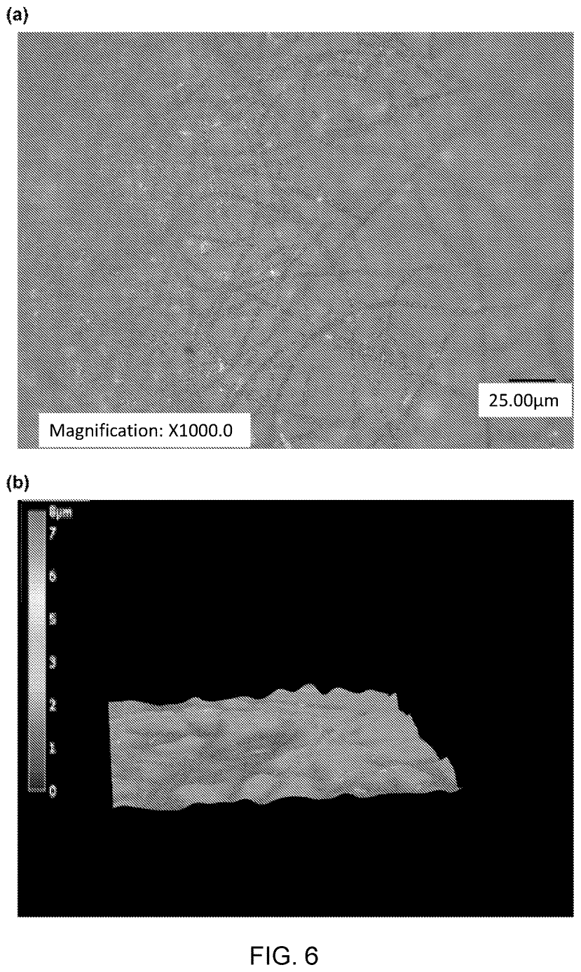

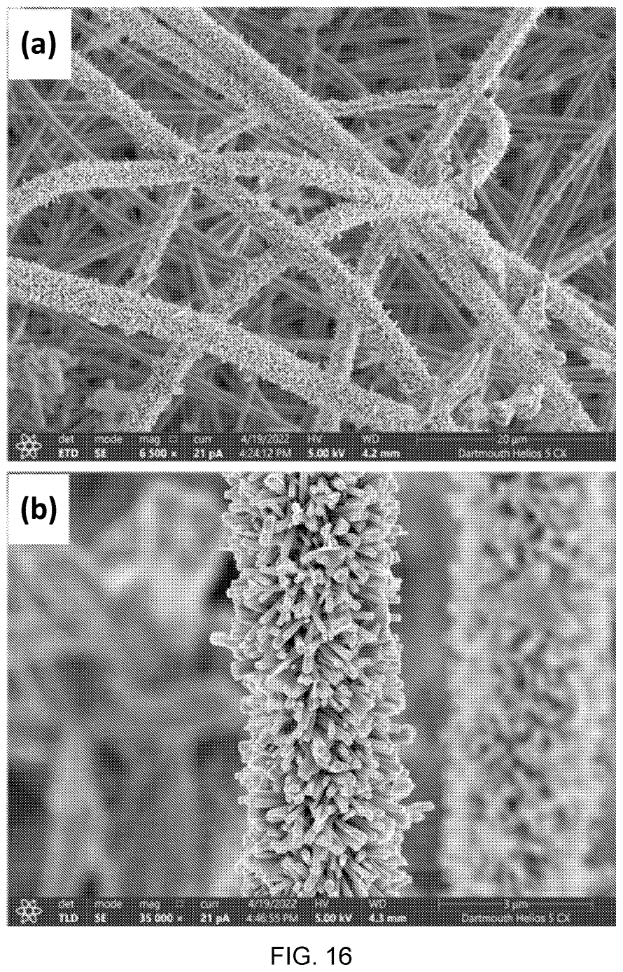

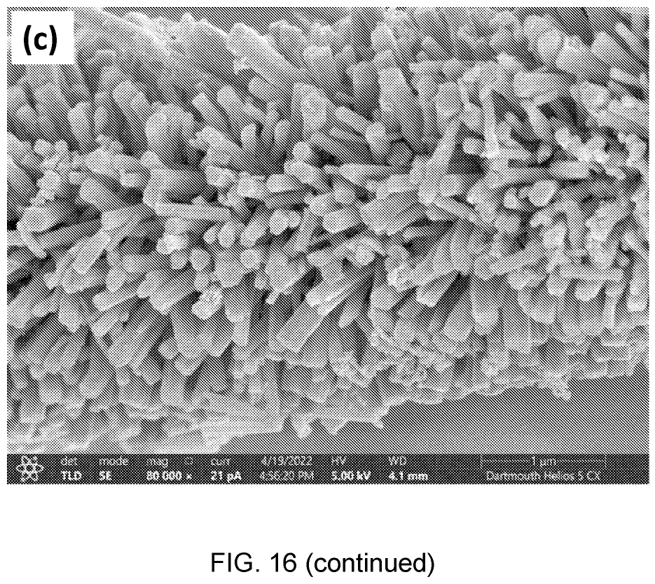

The as-fabricated chip was then characterized by SEM and EDS, as shown in FIGS. 2(b1)-2(b4) and FIGS. 2(c1)-2(c4). FIG. 2(a) shows the electrospun SNF on which ZnONRs were grown using a hydrothermal method. The SNF intertwines with each other and forms a SNF thin film. FIG. 2(b4) is a zoomed-in SEM image that shows AgNPs distributed on the ZnONRs. Some AgNPs are shown on the top of the ZnONRs, while others are shown on the side walls of the ZnONRs, creating a three dimensionally distributed AgNPs scenario, while pure ZnONRs have smooth surface (FIGS. 5(a)-5(c) and FIGS. 16(a)-16(c)). FIG. 2(c1)-2(c4) shows the EDS chemical mapping confirming the existence of the element Zn, O, and Ag and showing their uniform distribution in the sample. The characteristic X-ray energy of the key elements Zn, Si, O and Ag are plotted and labeled in the energy spectrum as shown in FIG. 2(e). The Ag element has its characteristic energies at 2.98 keV and 3.15 keV; Zn element has its characteristic energy at 1.01 keV; O has its characteristic energy at 0.52 keV; and Si has its characteristic energy at 1.74 keV. Optical images were taken by Keyence 3D Microscope with high magnification reveal the fibrous and 3D structure of the AgNP—ZnONR—SNF thin film (FIGS. 6(a)-6(b)).

Specifically, FIGS. 2(a)-2(f) display the fabrication and characterization of the AgNP—ZnONR—SNF thin film. FIG. 2(a) displays a schematic diagram which describes the synthesis procedure of the ZnONR and AgNP on electrospun SNF thin film. FIG. 2(b) displays scanning electron microscopy (SEM) image of the SNF (b1), ZnONR—SNF (b2) and (b3) and AgNP on the top of the ZnONR (b4). FIG. 2(c) displays energy dispersive spectrometry (EDS) mapping of the AgNP—ZnO—SNF, including a SEM image (c1), Zn element (c2), O element (c3), and Ag element (c4). FIG. 2(d) displays a diameter distribution of the SNF, AgNP, and ZnONR—SNF in semi-logarithmic plot. FIG. 2(e) displays an EDS spectrum of the AgNP—ZnO—SNF. FIG. 2(f) displays a normalized UV-Visible optical absorption spectrum of the ZnONR—SNF and AgNP—ZnO—SNF.

### Piezo-Catalytic and Photo-Catalytic Degradation of ZnONR—SNF

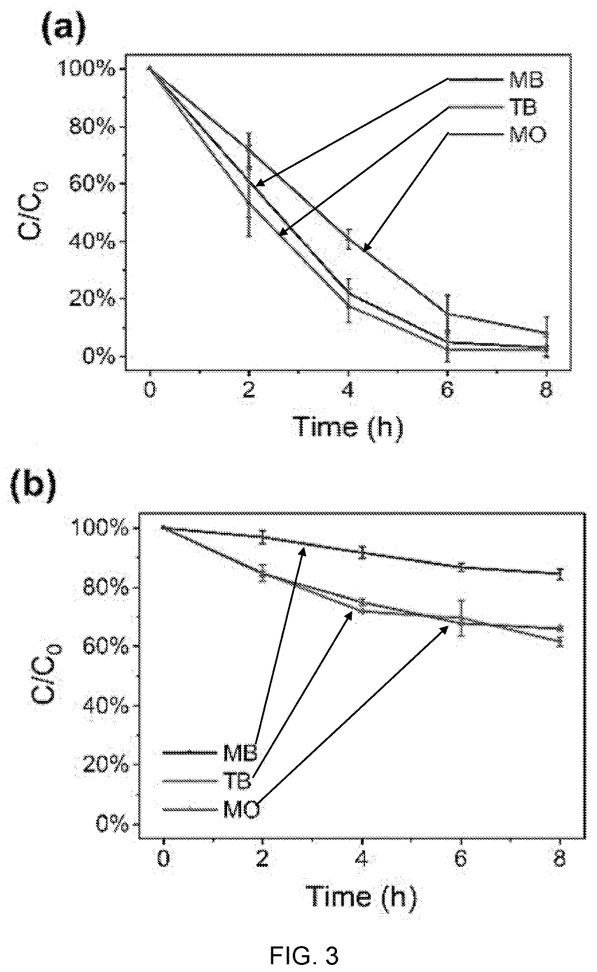

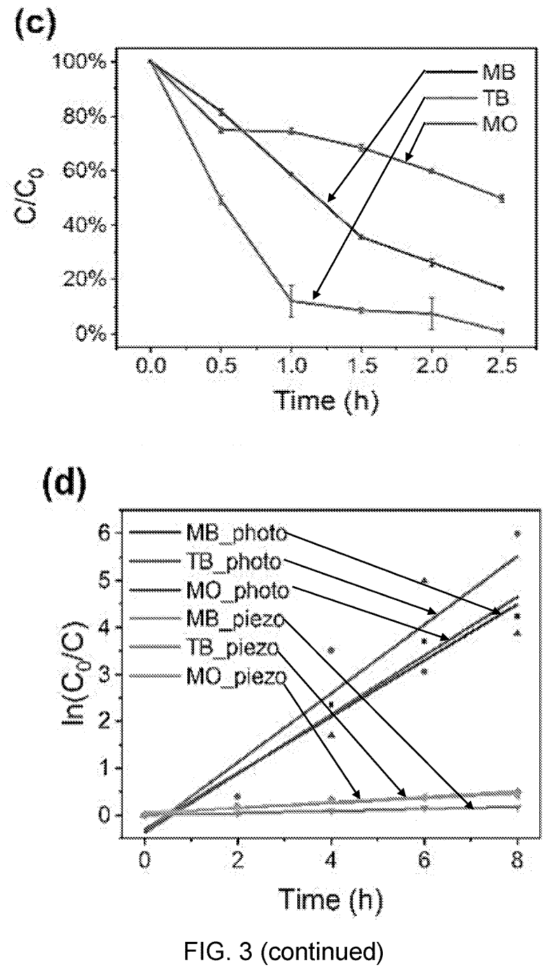

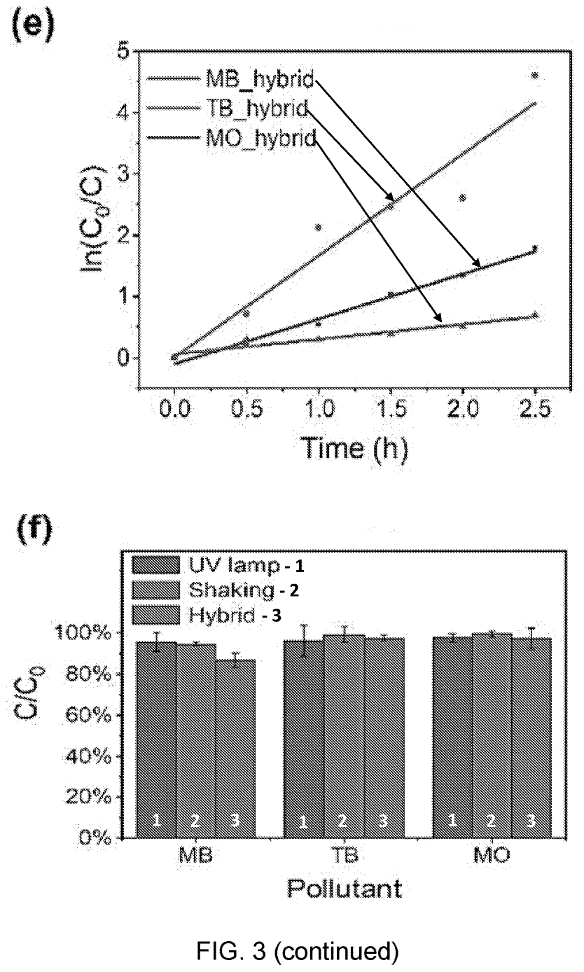

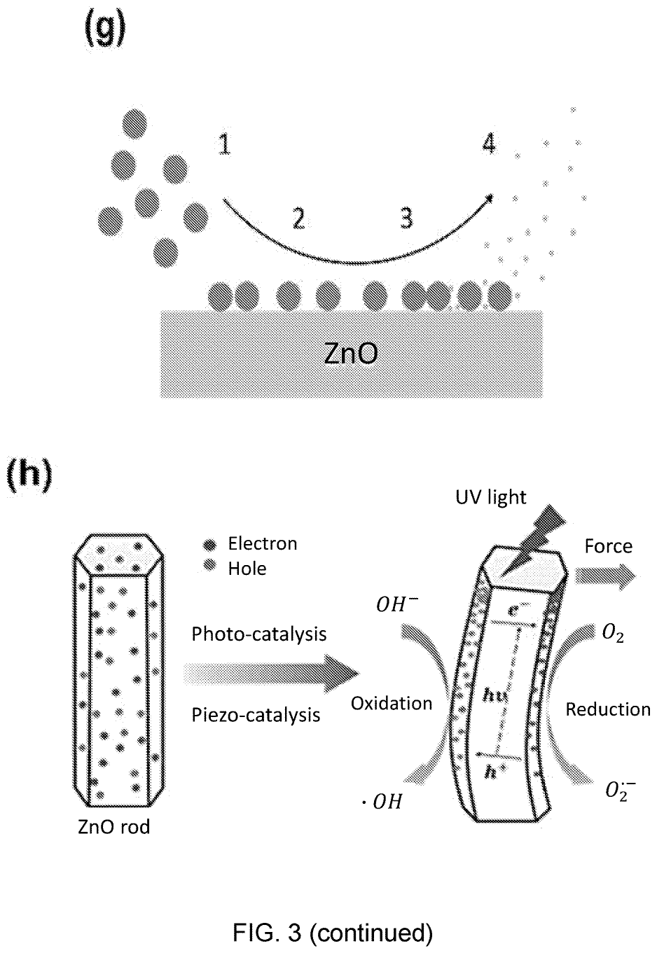

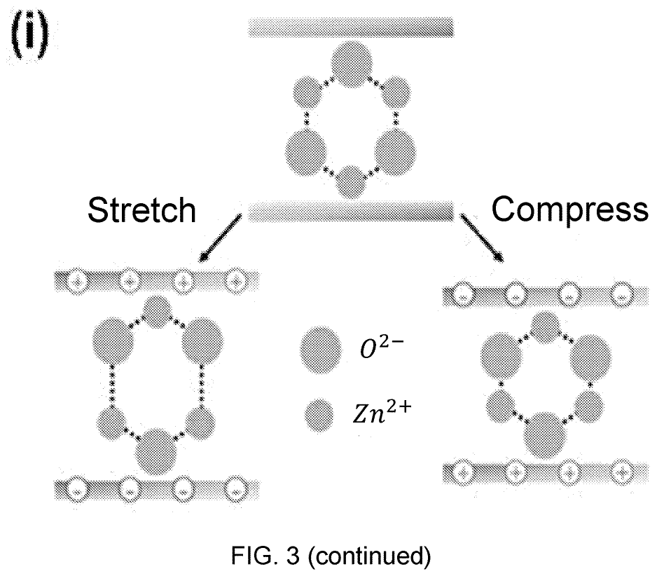

This example investigated the piezo-catalytic and the photo-catalytic activities of ZnONR—SNF thin films in the degradation of organic dyes (MB, TB and MO) with an initial concentration of 10 μg/mL. The experimental setup included an orbiting shaker and a UV lamp. Control experiments indicated that solar UV irradiation and shaking without any photocatalyst was negligible, and the concentration of the dyes remained almost unchanged. In the presence of ZnONR—SNF thin film, a degradation efficiency greater than 98% was achieved against the three organic dyes after 8 hours of exposure to the UV light. FIGS. 3(a)-3(c) show the change in concentration of those organic pollutants as a function of time at different conditions. The decline of the light absorbance intensity of the organic dyes at their characteristic peak wavelength was due to the cleavage of chromophore groups, which was responsible for the dye decoloration. These organic molecules were further decomposed separately under sunlight. Photocatalytic degradation efficiency for samples after 2 hours of sunlight exposure was even higher than under the UV lamp. Rate constants (k) for photocatalytic degradation are shown in FIGS. 3(d) and 3(e). The results confirm the photocatalytic property of ZnONR—SNF thin films.

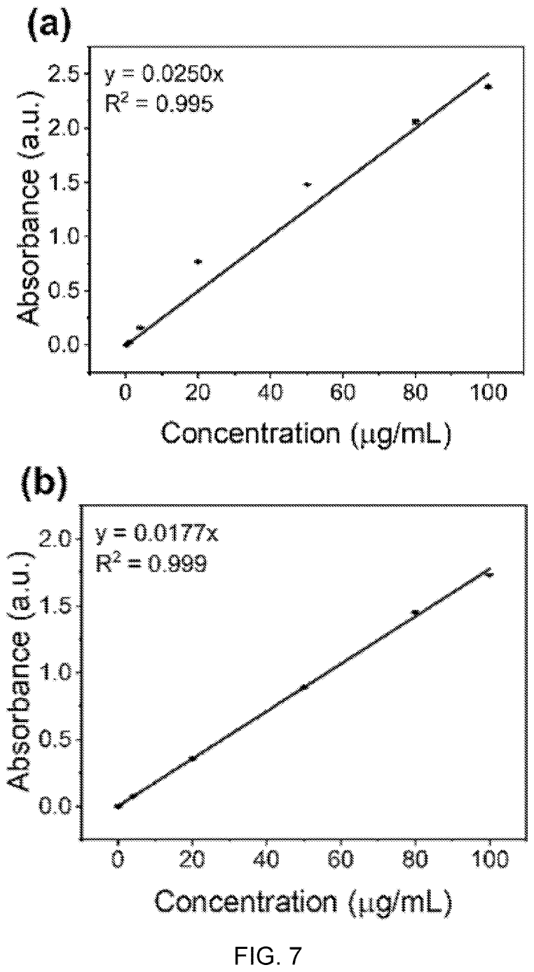

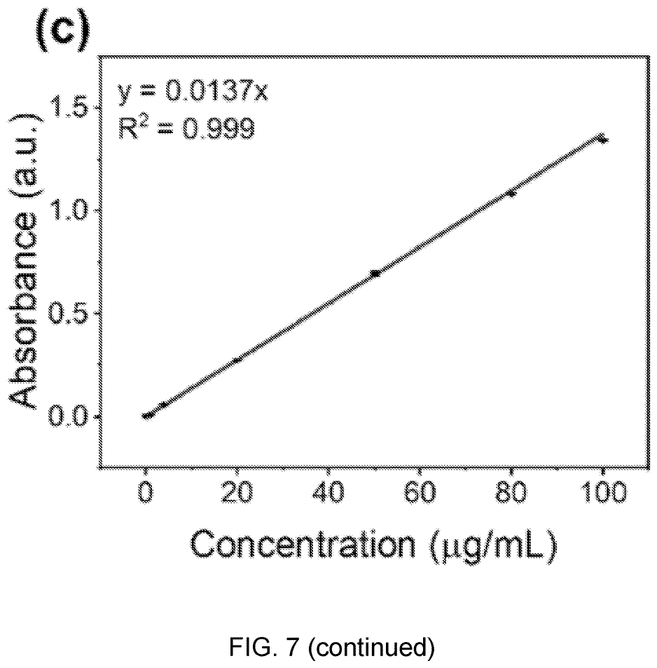

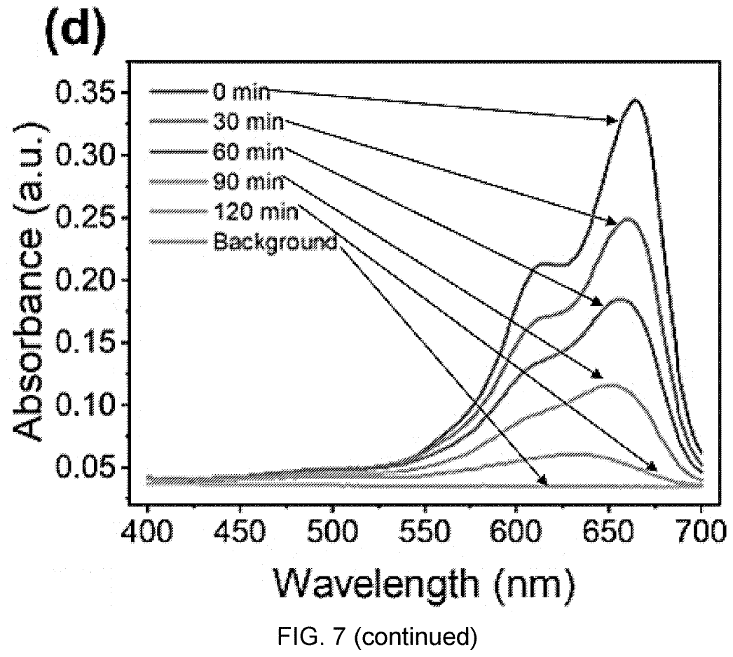

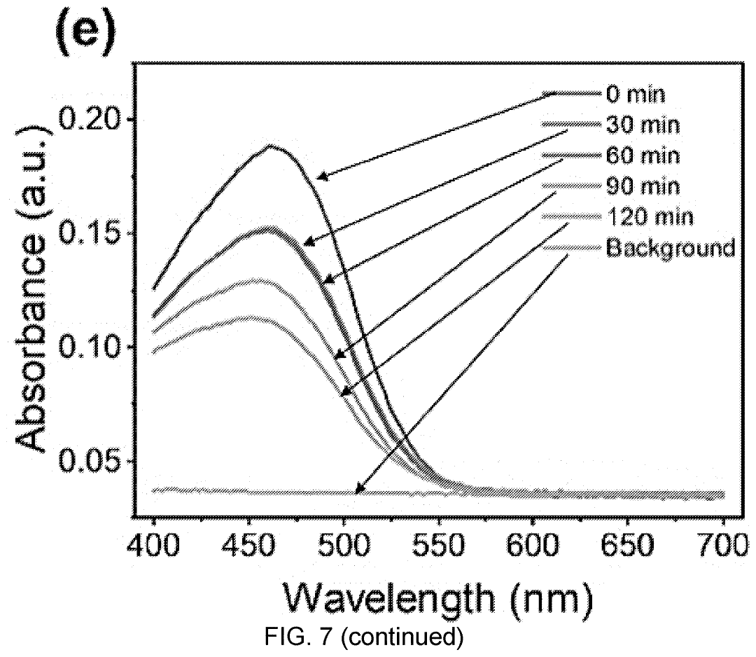

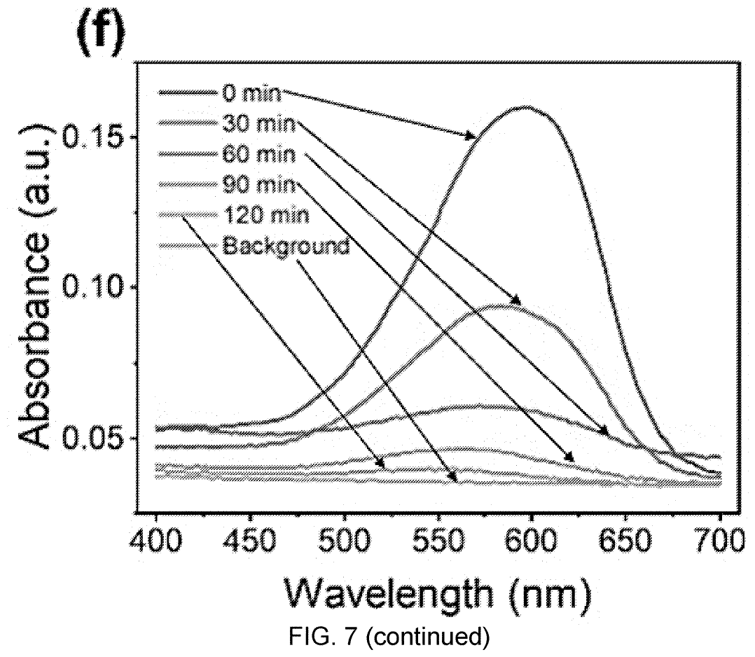

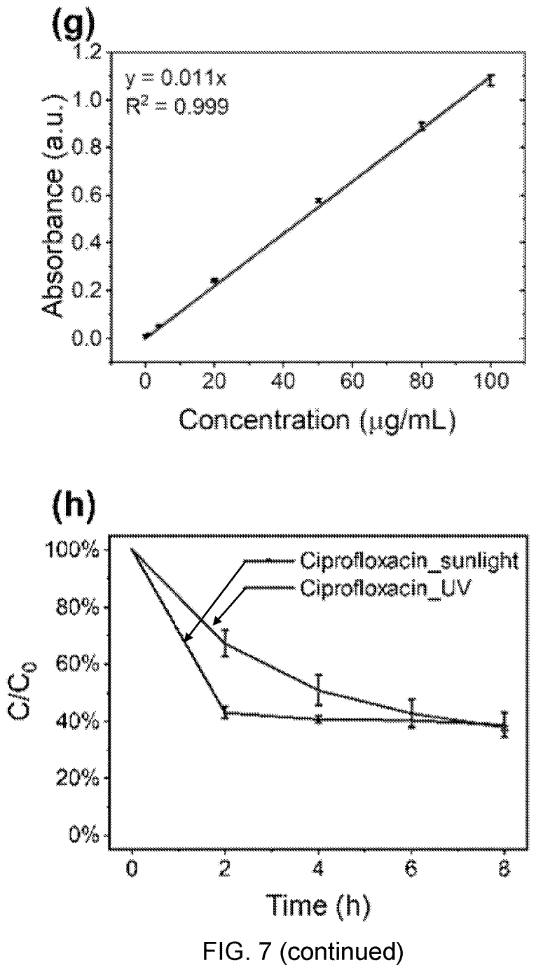

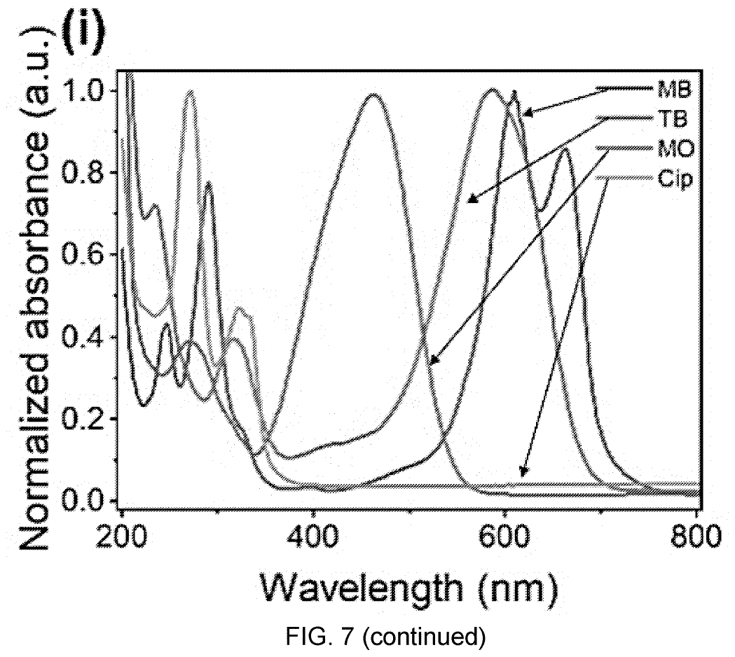

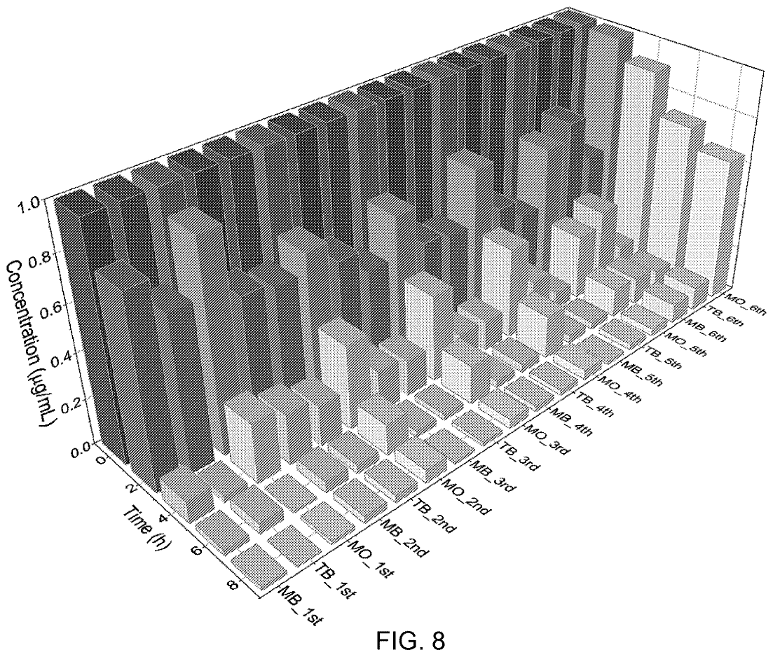

The reusability of the ZnONR—SNF thin film is also an essential factor as its efficiency in the photocatalytic degradation. In addition to organic dyes, photocatalysis degradation against antibiotic (Cip) was also studied under both UV light and sunlight (FIGS. 7(a)-7(i)). The same ZnONR—SNF samples were used to degrade MB, TB, and MO under a UV lamp and dried in an oven at 50° C. for multiple cycles. For the five cycles, the photocatalytic efficiency of ZnONR—SNF thin films remained high (FIG. 8). The photocatalytic degradation against organic molecules can be explained by the physical and optical properties of ZnO, as shown in FIG. 3(h). First organic pollutants diffuse from the liquid phase and are absorbed to the surface of ZnONR. Then ZnONR is irradiated by the UV light with energy larger than its bandgap energy, which promotes electrons (e⁻) from valence band (VB) to conduction band (CB) and leave holes (h⁺) in the VB. Next, the photogenerated electron-hole (e⁻/h⁺) pairs can migrate to the ZnO nanorod surface, reacting with water and hydroxide ions (by h⁺) and oxygen (by e⁻) to generate reactive oxygen species (ROS) including hydroxyl radical (·OH) and superoxide anion (O₂^{·-}). Finally, the ROS can directly oxidize organic pollutant molecules.

The piezo-catalytic activity of ZnONR—SNF thin film on degrading organic dye solution is shown in FIG. 3(b). Experiments were performed by stimulating the catalyst through orbiting shaking. The shaker motor rating output was 13.5 W. Under 8 hours reaction, the photocatalytic efficiency of MB, TB, and MO, reached 15.5%, 38.4% and 34.1%, respectively. Upon interaction with mechanical force (generated by the water flow), ZnONR was deformed and a strain field was created by the deflection with the outer side stretched while the inner side was compressed (FIG. 3(h)). An electric field along the ZnONR was then created inside through the piezoelectric effect, producing surface charge accumulation at the opposite surface. This allowed e⁻/h⁺ to migrate to the ZnONR surface, and triggered subsequent reactions similarly to the photocatalytic degradation process. The piezoelectric potential also contributed to the adsorption of charged organic molecules.

Hybrid experiments were also executed, where both UV lamp and shaker were used. After 2 hours irradiation, 96.3% of MB, 66.4% of TB, and 34.8% of MO were degraded, which is greater than the two catalytic activities alone. The improvement of the degradation efficiency may be explained by considering the flowing water and the semiconducting nature of ZnONR. Circulating water flow created by the orbiting shaker not only deflected ZnONR to create piezoelectric potential between the opposite surface but conduced to the adsorption of organic molecules in the water flow. Moreover, a piezoelectric potential along the nanorod direction was generated by the relative displacement of the Zn²⁺ cations with respect to the O²⁻ anions in the wurtzite crystal structure, as shown in FIG. 3(i), when the ZnONR is bent. The potential difference maintains as long as the strain exists and creates a potential difference between the compressed and the stretched side surface. Correspondingly, the recombination of photo-induced e⁻/h⁺ pairs inside the ZnONR may be impeded, leading to more efficient carrier separation. Eventually, more redox reaction occurs on the surface of ZnONR to improve the photocatalytic degradation.

FIGS. 3(a)-3(i) display a schematic illustration of the degradation mechanism and degradation results, as described herein. FIG. 3(a) displays a schematic illustration of the degradation process. FIG. 3(b) displays a schematic graph showing the piezo-catalytic and photo-catalytic degradation process of the ZnONR. FIG. 3(c) displays a schematic diagram of the piezoelectric property of ZnO. FIG. 3(d) displays photocatalytic degradation results. FIG. 3(e) displays piezo-catalytic degradation results. FIG. 3(f) displays hybrid degradation results. FIG. 3(g) displays photo-catalytic and piezo-catalytic degradation kinetic curves of dye solutions catalyzed by the ZnONR—SNF. FIG. 3(h) displays hybrid degradation kinetic curves of dye solutions catalyzed by the ZnONR—SNF. FIG. 3(i) displays degradation results of control groups without the ZnONR—SNF.

### SERS Detection

Organic dyes from the fabric industry are a major threat to water safety. Medical waste such as antibiotics are also having an increasingly negative impact on water safety. Raman spectroscopy provides a label-free and rapid tool for sensing organic molecules. Embodiments of the present disclosure include a SERS approach for quantitatively measuring the concentration of organic dyes and antibiotics.

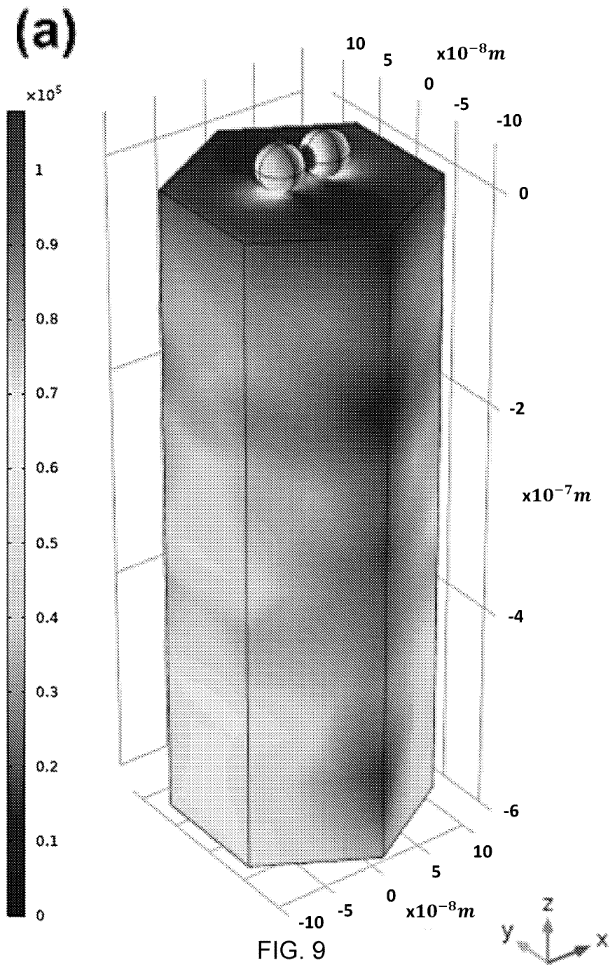

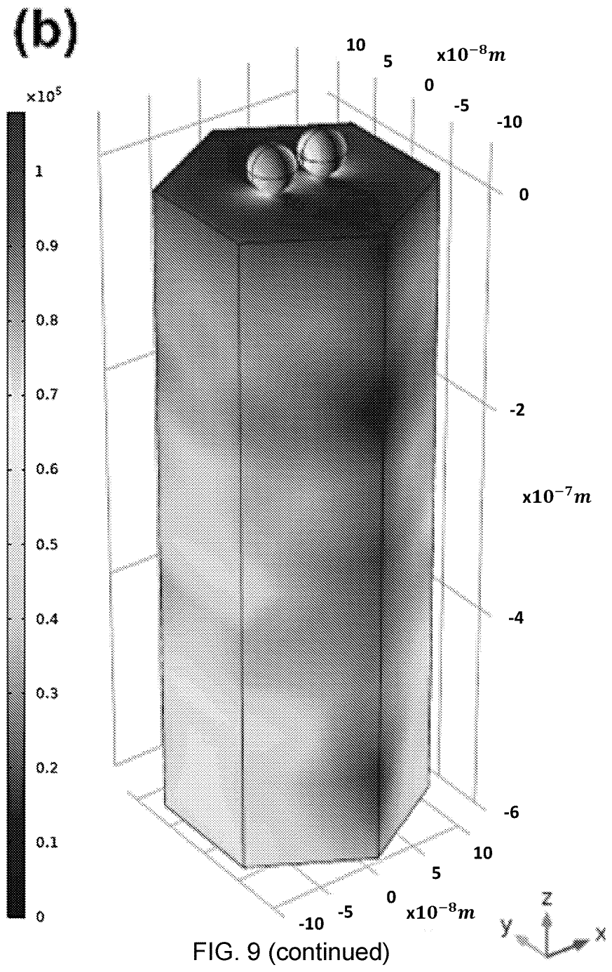

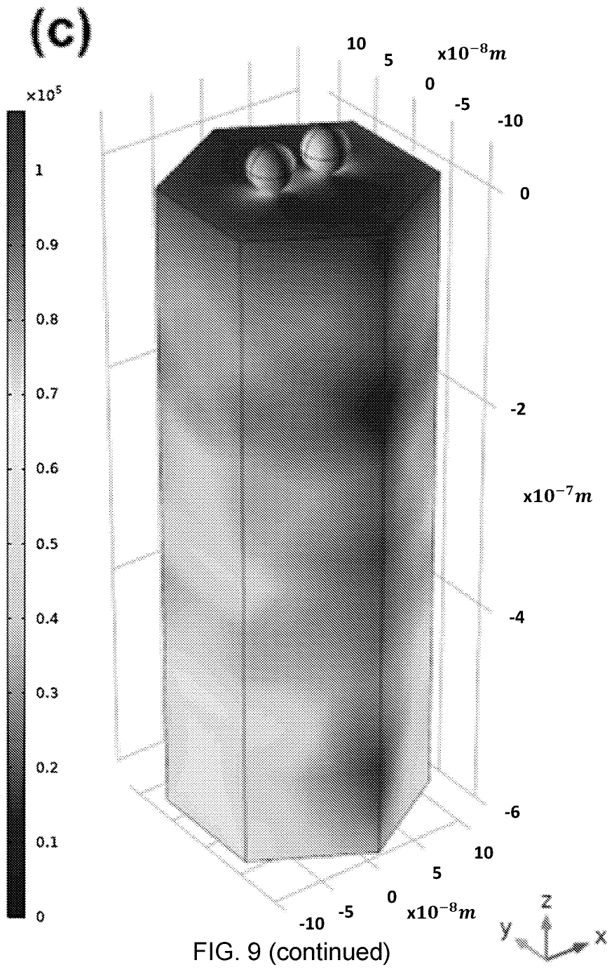

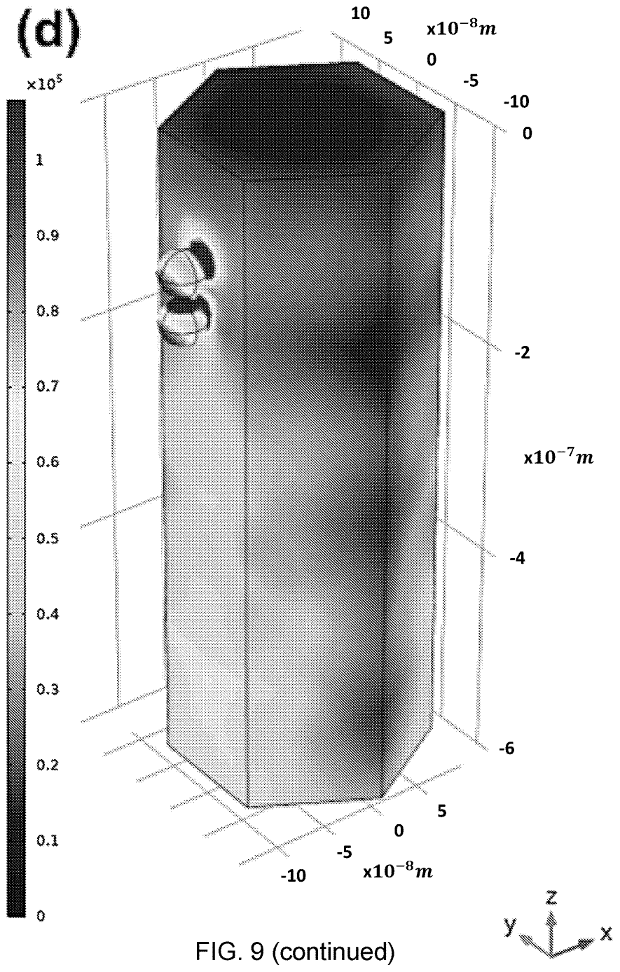

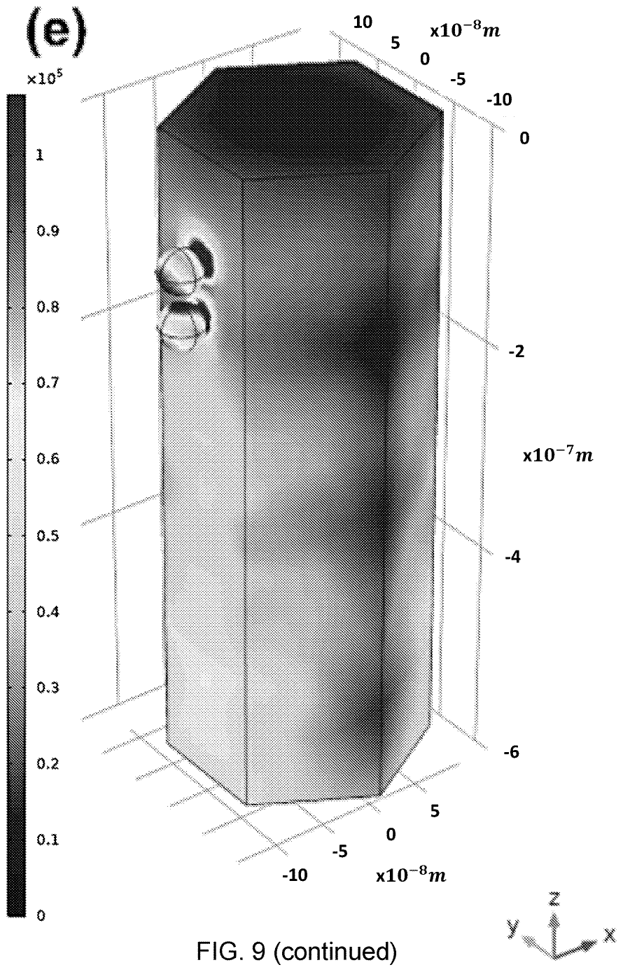

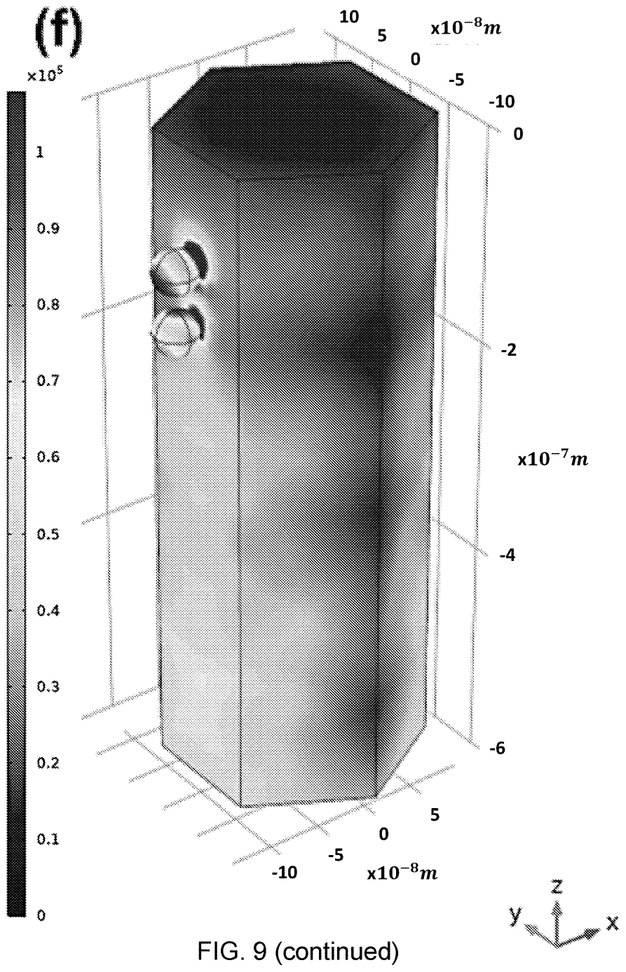

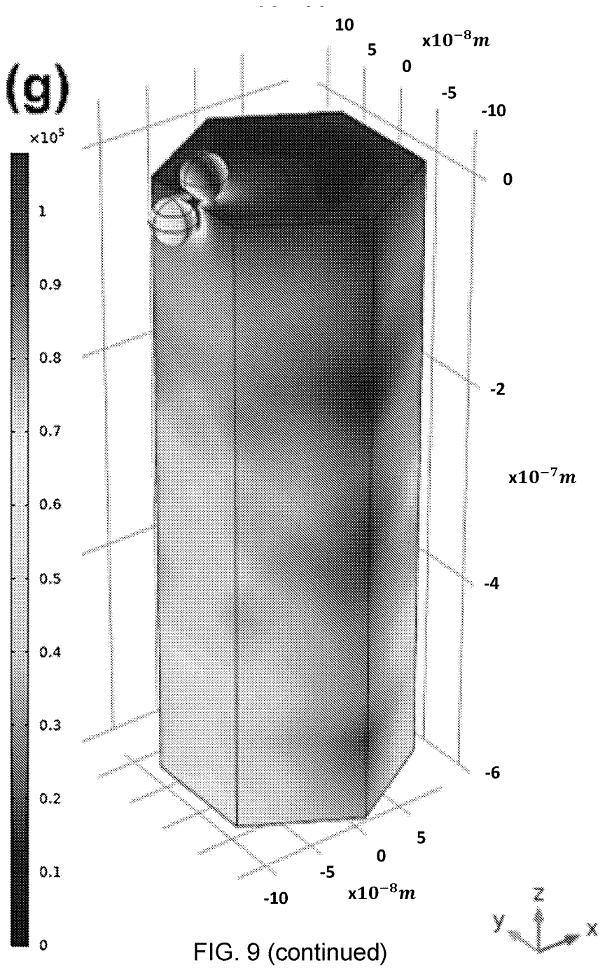

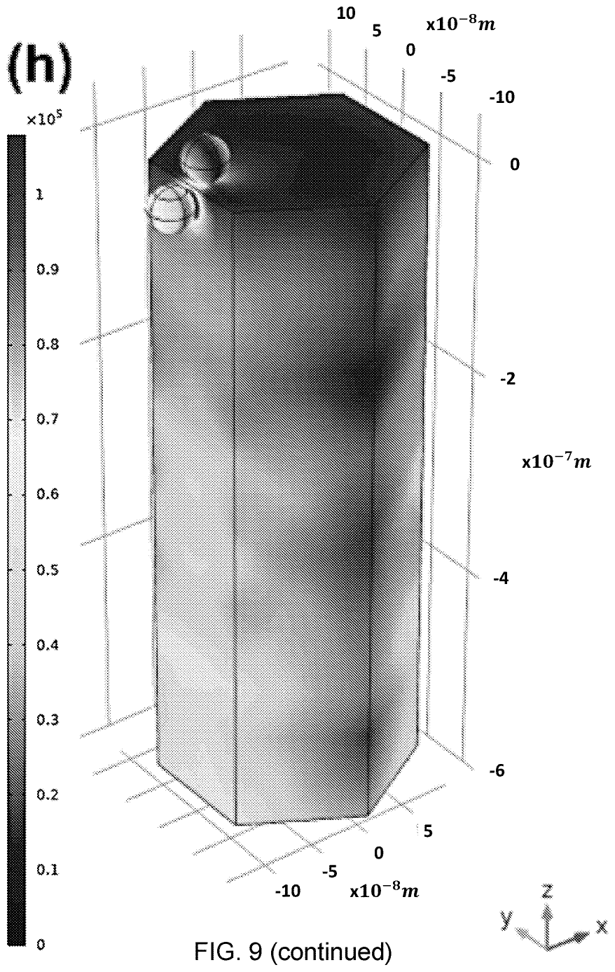

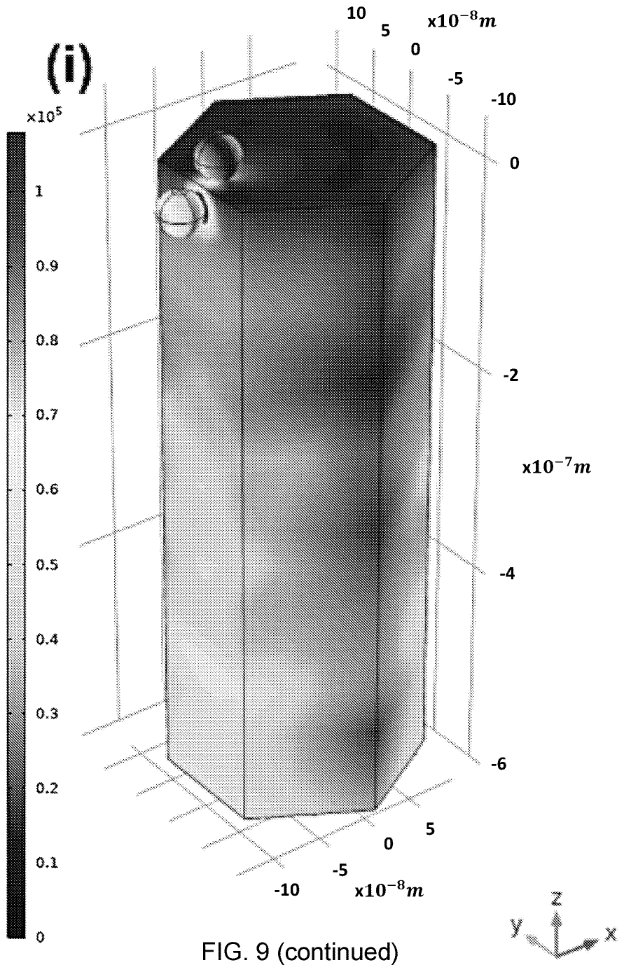

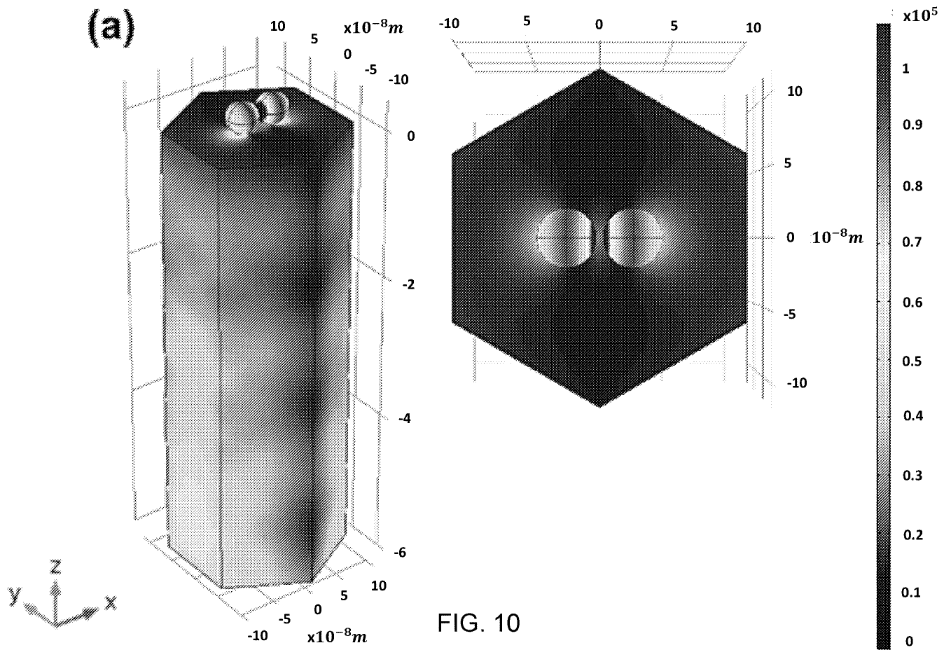

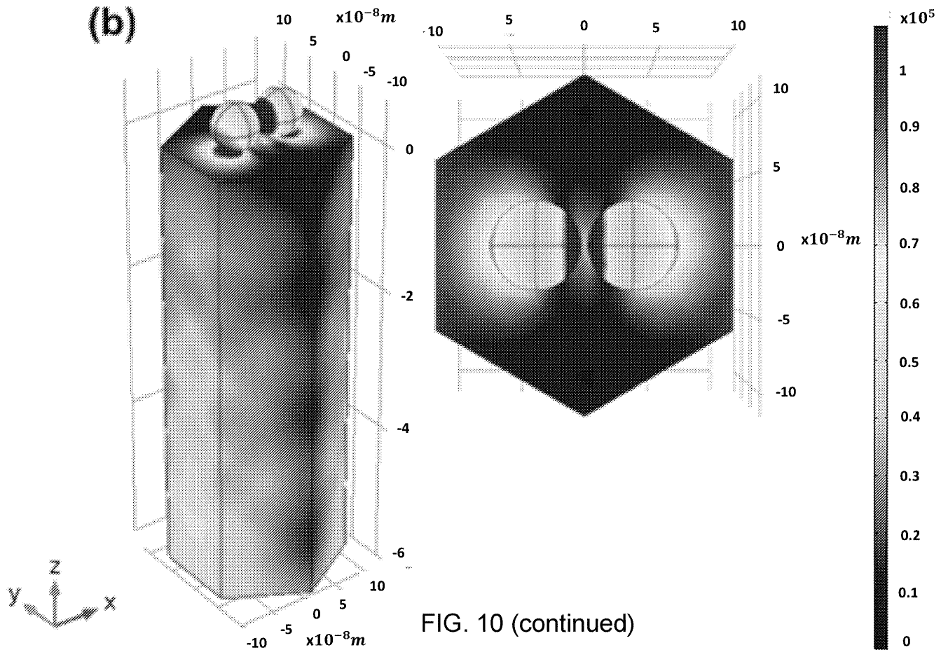

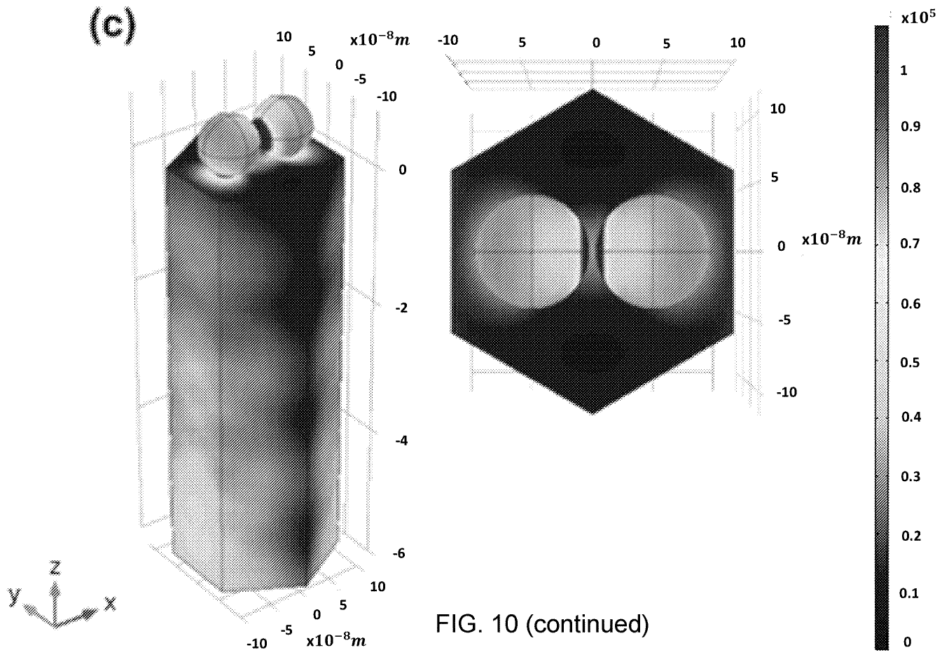

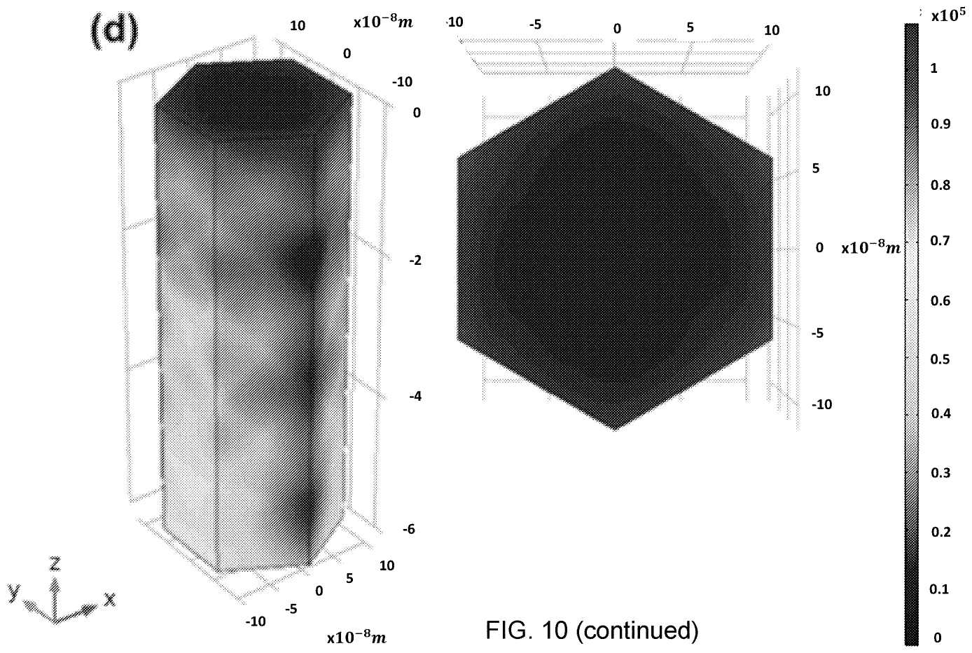

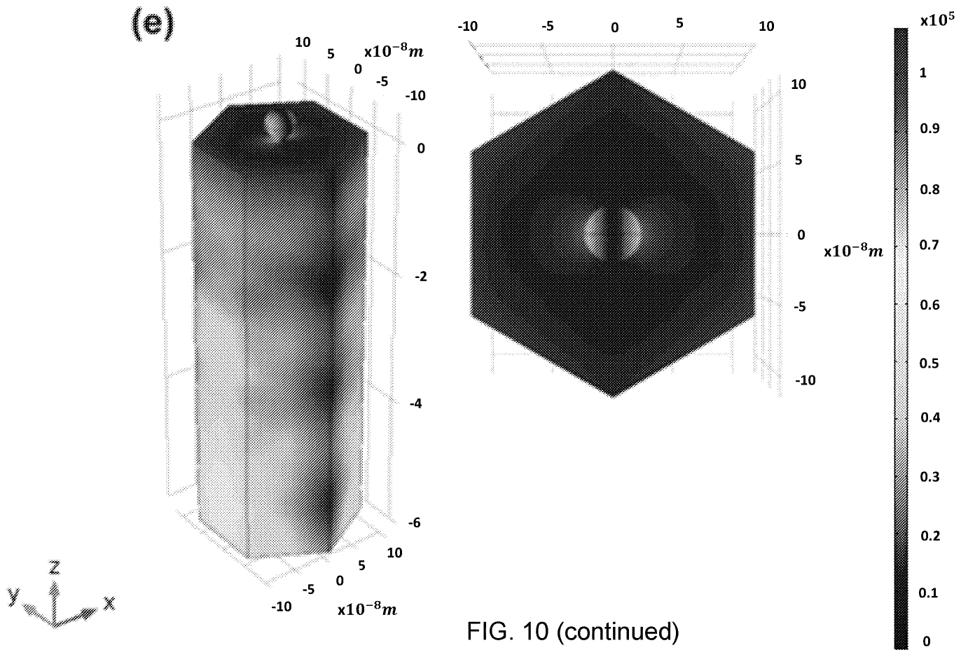

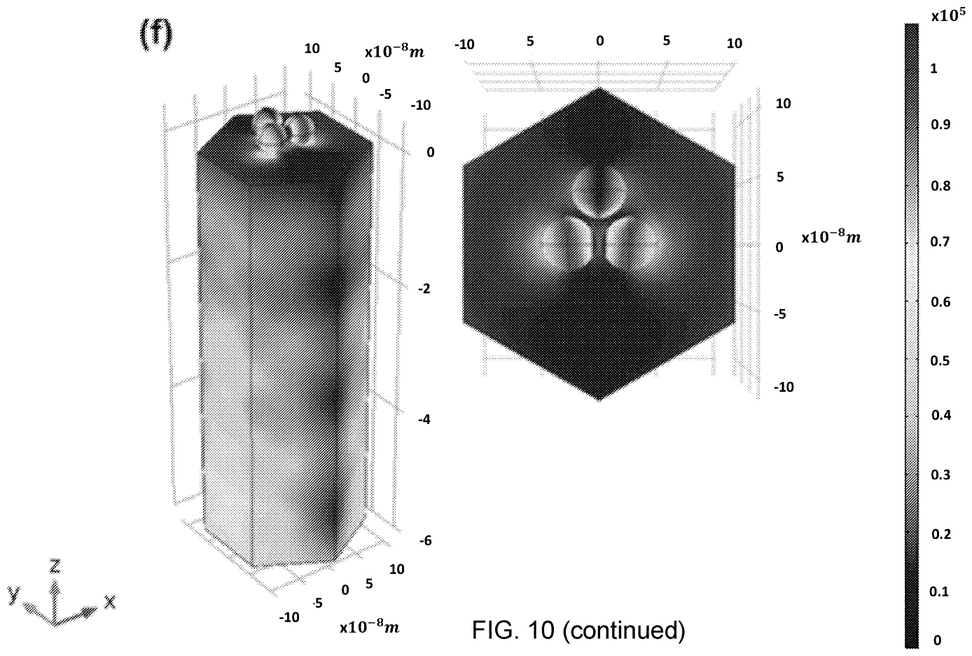

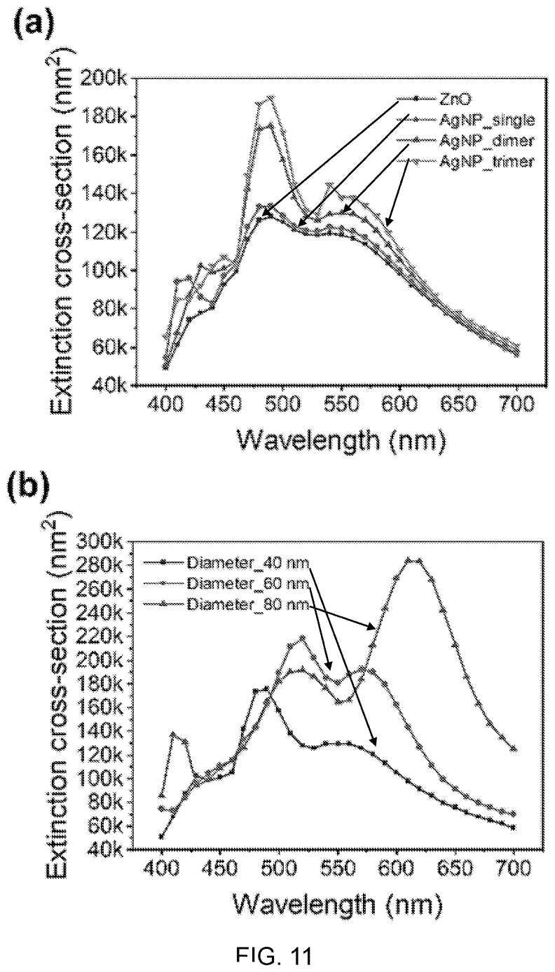

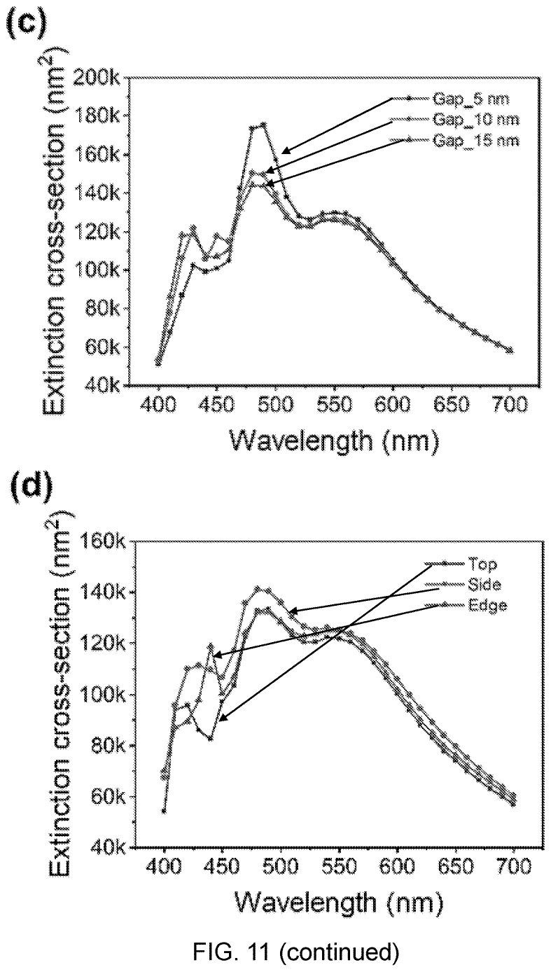

Prior to the Raman experiments, the enhancement of localized surface plasmonic resonance caused by AgNP decoration was simulated using a finite element method (FEM) by COMSOL. From the SEM images, it was found that there are three scenarios of AgNP placement: on the top side, on the side wall, and at the edge of ZnONR (FIGS. 9(a)-9(i)). In these scenarios, when AgNPs are in a close proximity and are coupling with incident light, the plasmonic hotspot region where localized electromagnetic field is dramatically enhanced occurs. The enhanced electromagnetic field can amplify SERS intensity to the fourth power of field enhancement, and the hotspot sites created by AgNP dimers generate more than 50% of the total SERS signal with only 1% of total surface area. AgNP trimer structure on the top of ZnONR can even better enhance the field (FIGS. 10(a)-10(f)), which aligns with the experiment observation. According to the simulation results, the diameter and the gap between the AgNPs will affect the enhancement factor, while the locations have limited effect (FIGS. 11(a)-11(d)). As most of the peaks of the extinction cross-section area for all AgNP arrangements lay in the range from 475 nm to 525 nm, we choose 532 nm laser as the excitation source.

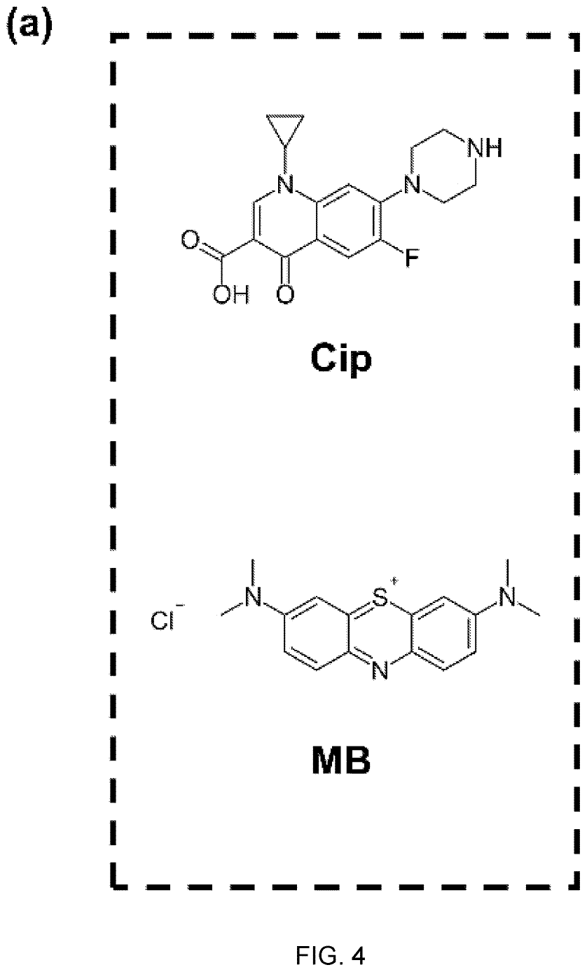

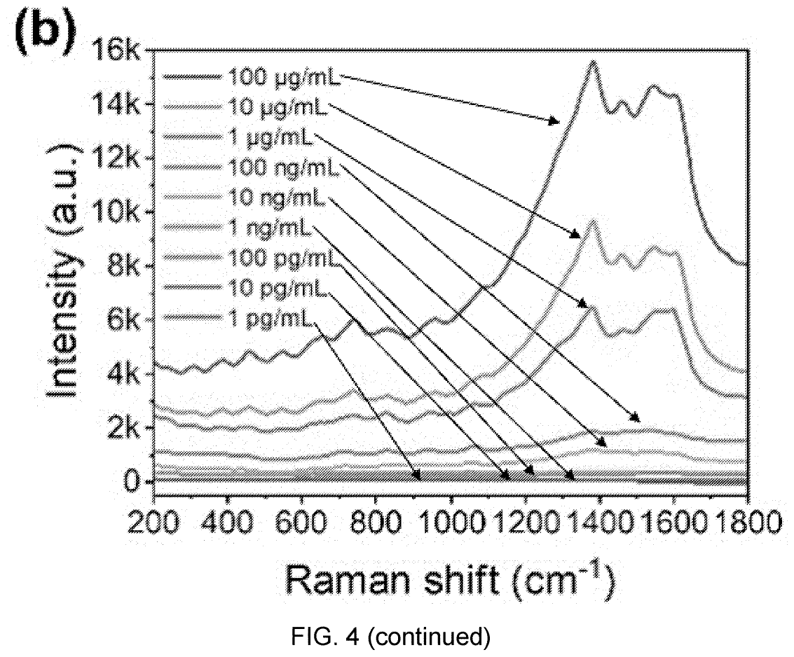

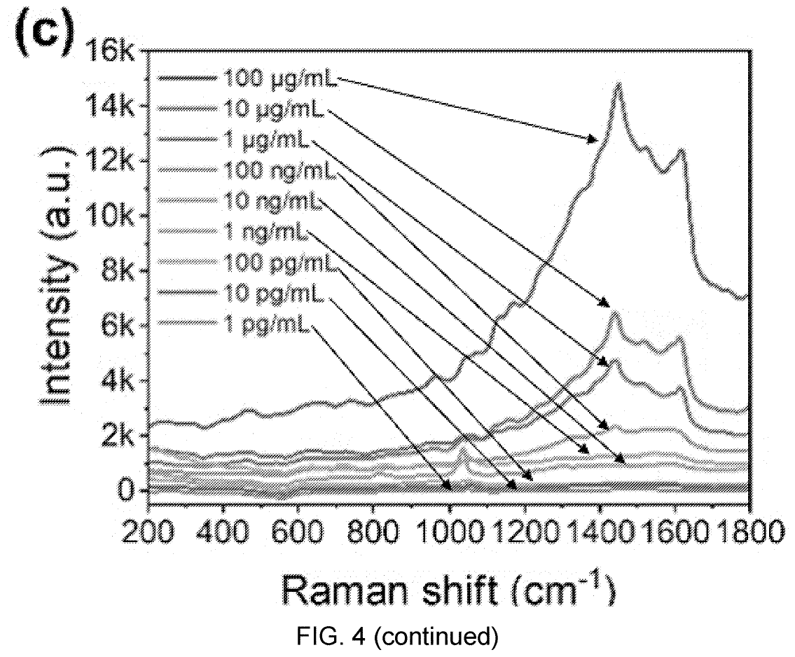

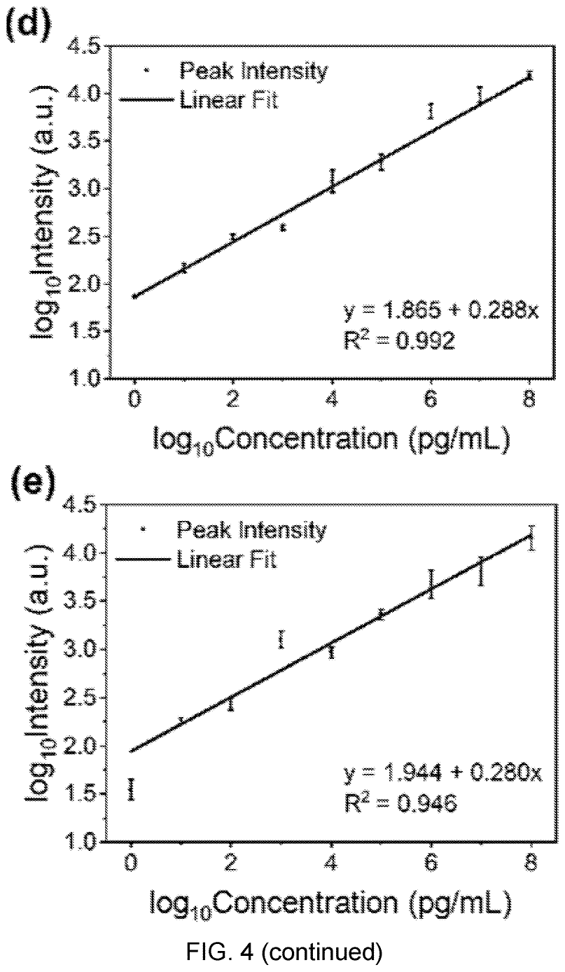

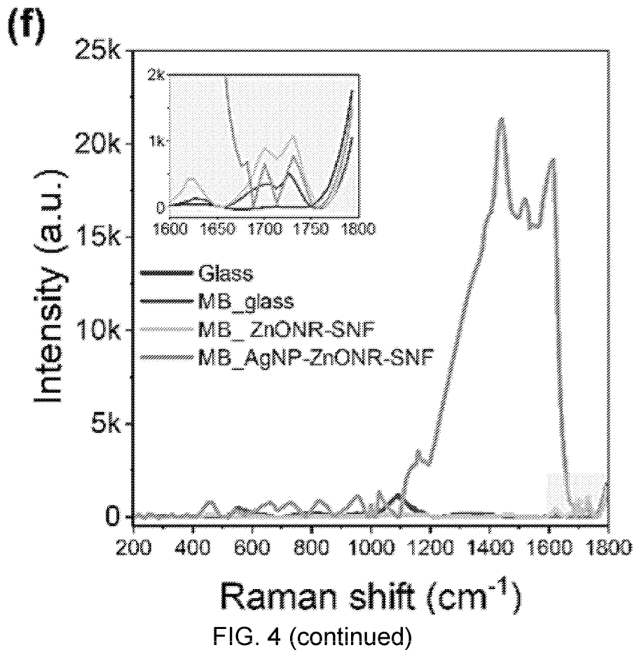

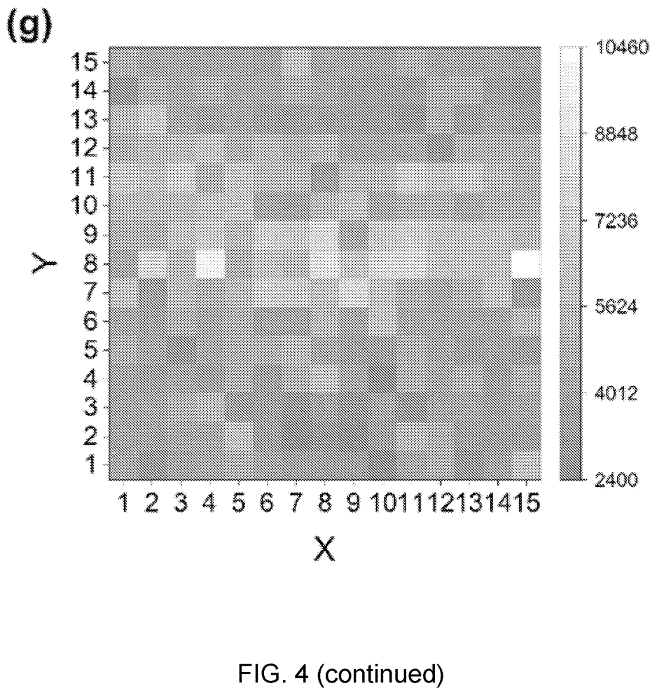

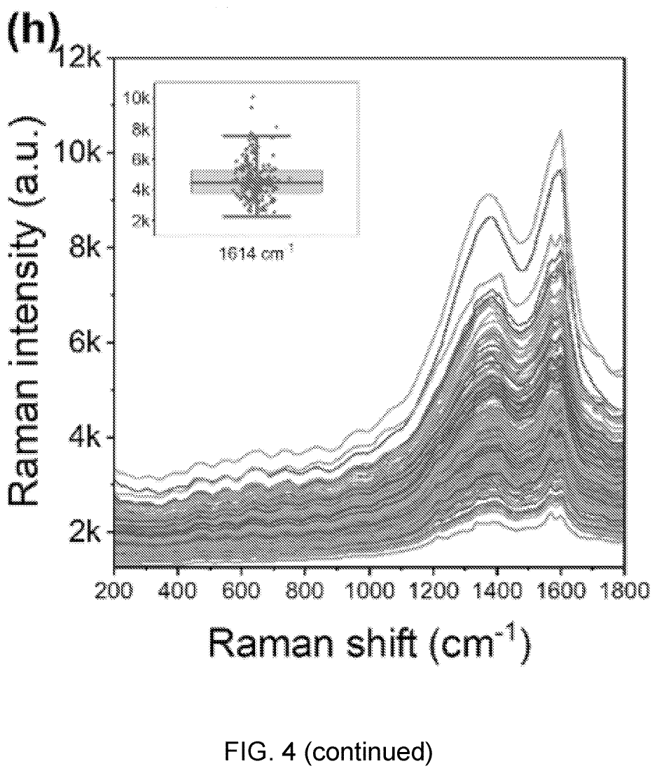

In the Raman experiments, MB and Cip, the chemical structures as shown in FIG. 4(a), dissolved in DI water, were used as demonstrations. In the test, 10 μL of the sample solution were dropped on the AgNP—ZnONR—SNF chip which had a size about 10 mm×10 mm. FIG. 4(b) and FIG. 4(c) show the raw Raman spectrum of the Cip and MB samples, respectively, of concentrations 100 μg/mL, 10 μg/mL, 1 μg/mL, 100 ng/ml, 10 ng/ml, 1 ng/mL, 100 μg/mL, 10 μg/mL, and 1 μg/mL. The most distinguishable characteristic peaks of the Cip were at 1382 cm⁻¹, 1465 cm⁻¹, 1605 cm⁻¹, and 1548 cm⁻¹, and MB at 1437 cm⁻¹ and 1614 cm⁻¹. As shown, there was a general trend of concentration of the samples being proportional to the intensity of the Raman signal. Therefore, the intensity of the highest peaks of the MB (1437 cm⁻¹) and Cip (1382 cm⁻¹) dyes were plotted against their concentrations as shown in FIG. 4(d) and FIG. 4(e), respectively, on log₁₀ scale. MB and Cip show a high linearity of R²=0.992 and 0.946, respectively, demonstrating that the embodiment of the device's functionality as a sensor can quantitatively monitor the concentration of organic dyes and antibiotics in water.

To demonstrate the favorable signal enhancement from the AgNP—ZnONR—SNF chip, Raman tests were performed on various substrates. They included a pristine glass substrate with no specimen, a glass substrate with a drop (10 μL) of MB, ZnONR—SNF with a drop of MB, and AgNP—ZnONR—SNF with a drop of MB. The intensity at the 1437 cm⁻¹ peak of MB on the AgNP—ZnONR—SNF, ZnONR—SNF, and the glass substrate were 19861.9, 62.1, and 18.8, respectively. It was determined that the intensity from the ZnONR—SNF substrate was increased 3.3 times that from the glass substrate, and the intensity from the AgNP—ZnONR—SNF sensor was increased 1056 times that from the glass substrate. The inset of FIG. 4(f) shows the spectrum in the 1600 cm⁻¹-1800 cm⁻¹ range within which there are two other characteristic peaks of MB at 1700 cm⁻¹ and 1732 cm⁻¹. The intensities from the AgNP—ZnONR—SNF are 645.3 and 778.2, respectively which is about 1.8 times those from the glass substrate.

In this example, it was demonstrated that the SERS enhancement of the sensor mainly occurs in the range from approximately 10⁵⁰ cm⁻¹ to 1650 cm⁻¹ where the enhancement was up to 1056 folds while the enhancement outside the range was less than 2 folds. Many factors determined the major enhancement range including the particle material such as Ag, Au, or other noble metal and the geometry of the nanomaterials such as the particle size. Therefore, it was determined that to have a large enhancement in a larger range or in the entire wavelength spectrum, more than one type of nanoparticles and various sizes may be decorated on the ZnO nanorod. In addition, the AgNP—ZnONR—SNF chip showed to have a relatively consistent and uniform sensing performance on the chip surface. The signal intensity of the highest peak (1614 cm⁻¹) of MB dye was plotted on a color map (15×15 data points on an area of 400×400 μm² on the sensing chip) with the color variants representing the magnitude of the intensity as shown in FIG. 4(g). As shown, the magnitude of the signal intensity was generally consistent across this testing area on a microscale Raman mapping analysis, indicating a uniform sensing performance across the chip. To further demonstrate the sensor's consistent performance across its sensing area, the 225 Raman spectrum curves are shown in FIG. 4(h). The inset box chart of FIG. 4(h) shows the distribution of the Raman signal intensity for the characteristic peak at 1614 cm⁻¹ of MB, in which 50% fall into the intensity range of 3800 to 5300. Therefore, embodiments tested in this example demonstrated that the AgNP—ZnONR—SNF sensor shows a uniform sensing performance across its surface.

As described, FIGS. 4(a)-4(h) display SERS detection of organic molecules using an AgNP—ZnONR—SNF thin film. FIG. 4(a) displays a chemical structure of antibiotic Cip and dye MB. FIG. 4(b) displays Raman spectra of Cip solution of various concentrations. FIG. 4(c) displays Raman spectra of MB solution of various concentrations. FIG. 4(d) displays the Raman intensity vs. concentration curve of Cip (in log₁₀ scale). FIG. 4(e) displays the Raman intensity vs. concentration curve of MB (in log₁₀ scale). FIG. 4(f) displays the SERS enhancement of MB dye (1 μg/mL) on different substrates. The inserted figure shows the zoomed area between 1600 cm⁻¹ and 1800 cm⁻¹. FIG. 4(g) displays Raman signal mapping (10×10 data points on an area of 400×400 μm²) of the 1614 cm⁻¹ characteristic peak of the MB dye showing uniform intensity across the AgNP—ZnONR—SNF chip. FIG. 4(h) displays 225 Raman spectra from FIG. 4(g) and the inset is the distribution of the intensity.

### ML-Assisted Detection

Raman spectra obtained by embodiments of the AgNP—ZnONR—SNF chip contained at least one vibrational fingerprint intrinsic to the molecule that can be used for the analyte identification. However, it can be difficult to correctly characterize and explain the molecular structural information in the mixtures where the characteristic peaks are likely overlapped. Therefore, embodiments of the present disclosure combine the machine learning methods to solve this problem.

As described, embodiments of the dual functional AgNP—ZnONR—SNF thin films were prepared via the combination of electrospinning, hydrothermal, and wet-chemical synthesis. The ZnONR—SNF thin films exhibit high piezo-catalytic and photo-catalytic activity for degrading organic dyes (MB, TB, and MO) under both low-powered UV and mechanical irradiation with excellent reusability. Embodiments of the present disclosure may be inexpensive, green, and efficient technologies for water decontamination against organic pollutants. In addition, vertically aligned ZnO nanorods provide suitable geometry to deposit Ag nanoparticles, which generate high-density hot spots for SERS enhancement in the detection of organic molecules. The detection of nano-molar concentrations of both organic dye (MB) and antibiotic (Cip) has been successfully demonstrated AgNP—ZnONR—SNF thin films as a SERS substrate. Embodiments of the algorithm have an accuracy of 92.3% in qualitative detection and 90.8% in quantitative classification. This detection method is sensitive, fast, label-free, and portable, as an effective and low-cost on-site water quality monitoring option.

Although the present disclosure has been described with respect to one or more particular embodiments and/or examples, it will be understood that other embodiments and/or examples of the present disclosure may be made without departing from the scope of the present disclosure.

1. A method comprising:
providing a test system, wherein the test system includes:
a silicon nanofiber film;
a plurality of ZnO nanorods arranged in an array on the silicon nanofiber film, wherein the plurality of ZnO nanorods have a top surface and a side surface, and wherein the side surface is arranged between the top surface and the silicon nanofiber film; and
a plurality of particles disposed on the plurality of ZnO nanorods;
applying a water sample to the test system; and
determining a concentration of a pollutant in the water sample using surface-enhanced Raman spectroscopy of the test system.

2. The method of claim 1, wherein the plurality of particles are disposed on the top surface and the side surface of one or more of the plurality of ZnO nanorods.

3. The method of claim 1, wherein each of the plurality of ZnO nanorods has a cross-sectional dimension of 200 nm to 3 μm.

4. The method of claim 1, wherein each of the plurality of particles has an average diameter of 20-100 nm.

5. The method of claim 1, wherein an average distance between the plurality of particles is 100 nm.

6. The method of claim 1, wherein a density of the plurality of ZnO nanorods is from 10-12 nanorods in every 100 μm² area.

7. The method of claim 1, wherein the silicon nanofiber-film has a diameter of 12 cm.

8. The method of claim 1 wherein the plurality of particles are silver particles, gold particles, platinum particles, or other particles including precious metals.

9. The method of claim 1, wherein the pollutant is an organic pollutant, an inorganic pollutant, a bacterial contaminant, or a virus.

10. The method of claim 9, wherein the pollutant is the organic pollutant, and wherein the organic pollutant is a dye.

11. The method of claim 1, wherein the determining includes using a machine learning algorithm to analyze measurements from the surface-enhanced Raman spectroscopy.

12. The method of claim 11, wherein the machine learning algorithm is a prior embedded neural network.

13. A non-transitory computer readable medium storing a program configured to instruct a processor to execute the machine learning algorithm of claim 11.
